(19) United States
(12) Patent Application Publication
(10) Pub. No.: US 2013/0296370 A1
(43) Pub. Date: Nov. 7, 2013

(54) COMPOSITION COMPRISING A PHOTOACTIVATABLE LARVICIDE

(71) Applicants: Piera Di Martino, Camerino (MC) (IT); Annette Habluetzel, Camerino (MC) (IT); Leonardo Lucantoni, Camerino (MC) (IT); Giulio Lupidi, Carmerino (MC) (IT); Olimpia Coppellotti, Padova (IT); Giulio Jori, Padova (IT); Michela Magaraggia, Asigliano Veneto (VI) (IT); Laura Guidolin, Longare (VI) (IT); Abdoulaye Diabate, Bobo-Dioulasso (BF); Jean Bosco Ouedraogo, Bobo-Dioulasso (BF); Kounbobr Roch Dabire, Bobo-Dioulasso (BF); Clara Fabris, Padova (IT)

(72) Inventors: Piera Di Martino, Camerino (MC) (IT); Annette Habluetzel, Camerino (MC) (IT); Leonardo Lucantoni, Camerino (MC) (IT); Giulio Lupidi, Carmerino (MC) (IT); Olimpia Coppellotti, Padova (IT); Giulio Jori, Padova (IT); Michela Magaraggia, Asigliano Veneto (VI) (IT); Laura Guidolin, Longare (VI) (IT); Abdoulaye Diabate, Bobo-Dioulasso (BF); Jean Bosco Ouedraogo, Bobo-Dioulasso (BF); Kounbobr Roch Dabire, Bobo-Dioulasso (BF); Clara Fabris, Padova (IT)

(73) Assignees: UNIVERSITA DEGLI STUDI DI PADOVA, Padova (IT); UNIVERSITA DEGLI STUDI DI CAMERINO, Camerino (IT) (IT)

(21) Appl. No.: 13/878,250

(22) PCT Filed: Oct. 7, 2011
(86) PCT No.: PCT/IB11/54425

§ 371 Date: Jul. 25, 2013

(30) Foreign Application Priority Data
Oct. 8, 2010 (IT) RM2010A000524

(51) Int. Cl. A01N 43/90; A23K 1/16

(52) U.S. Cl. CPC A01N 43/90; A23K 1/1625
USPC 514/333

(57) ABSTRACT

A composition comprising a photoactivatable larvicide and a suitable vector, the latter allowing the larvicide to be ingested by the larvae and a method for controlling mosquito larvae by using said photoactivatable larvicide are disclosed.

### TECHNICAL FIELD

The present invention refers to the field of insecticides, and more in particular to a composition comprising a photoactivatable larvicide and a suitable vector, the latter allowing the larvicide to be ingested by the larvae and a method for controlling mosquito larvae by using said photoactivatable larvicide as a food supplement to be applied in the environment where larvae develop.

### PRIOR ART

The strategic framework for the control of vectors of mosquito borne diseases, such as e.g., malaria, dengue, West Nile virus, yellow fever, filariasis, is currently represented by integrated vector management, IVM (WHO, Global strategic framework for integrated vector management, 2004), an approach that calls for an evidence-based and cost-effective choice of measures among all the available methods of disease vectors control.

The IVM strategy includes the possibility to use chemical larvicides for controlling mosquito vectors of diseases.

Insecticides currently used for mosquito larviciding are shown in the following table 1 (WHO, Pesticides and their application for the control of vectors and pests of public health importance, 2006).

TABLE 1
WHO-recommended compounds and formulations for the
control of mosquito larvae

| | | | | WHO |
|---|---|---|---|---|
| | | | | hazard |
| | | Dosage | | classi- |
| | Chemical | of ai | | fication |
| Insecticide | type | (g/ha) | Formulation | of ai^{a} |
| fuel oil | — | ^{b} | Solution | — |
| B. thuringiensis | Biopesticide | ^{c} | water-dispersible granule | — |
| israelensis | | | | |
| diflubenzuron | IGR | 25-100 | wettable powder | U |
| methoprene | IGR | 20-40 | emulsifiable concentrate | U |
| novaluron | IGR | 10-100 | emulsifiable concentrate | NA |
| pyriproxyfen | IGR | 5-10 | Granules | U |
| chlorpyrifos | organo- | 11-25 | emulsifiable concentrate | II |
| | phosphate | | | |
| fenthion | organo- | 22-112 | emulsifiable concentrate, | II |
| | phosphate | | granules | |
| pirimphos- | organo- | 50-500 | emulsifiable concentrate | III |
| methyl | phosphate | | | |
| temephos | organo- | 56-112 | emulsifiable concentrate, | U |
| | phosphate | | granules | |

Wherein ai means active ingredient; IGR means insect growth regulator;
^{a}has the following meanings: class II means moderately hazardous; class III means slightly hazardous; class U means unlikely to pose an acute hazard in normal use; NA means information not available;
^{b} means that the dosage of the active ingredient is 142-190 litre/ha or 19-47 litre/ha if a spreading agent is added;
^{c} means that the dosage of the active ingredient is 125-750 g of formulated product per hectare (open bodies of water), or 1-5 mg/l (artificial containers).

Examples of chemical larvicides are disclosed in the European Patents N. 0005912 N. 0265087.

The advantages of the currently used chemical larvicides are the fast killing action, the relatively long residual activity and the favourable cost effectiveness. The drawbacks of currently used chemical larvicides are: safety risks for humans and the environment, adverse effects on non-target biota, risk of inducing resistance in target insect populations, important pollution of various environments.

In recent years, the use of bacterial insecticides like Bacillus thuringiensis var. israelensis (Bti) and B. sphaericus (Bs), and insect growth regulators (IGRs) has gained prominence in comparison to organophosphate compounds, in response to the demand for safer and/or more pest-specific compounds. Bti and Bs produce a toxin peptide that, after ingestion, creates pores in the membrane of the epithelial cells lining the larval gastrointestinal tract, leading to irreversible gut tissue damage and larval death.

Such bacterial toxins are remarkably selective against mosquito larvae, therefore safe to vertebrates and non target arthropods; although the commonest formulations are not very persistent and frequent re-treatments are necessary.

Examples of bacterial insecticides are disclosed in European Patent N. 1367898.

Insect growth regulators (IGRs) like methoprene and pyriproxyfen are juvenile hormone analogues (juvenoids) that interfere with the metamorphosis of larvae into pupae and adults, while compounds such as triflumuron and novaluron are chitin synthesis inhibitors that block the formation of the cuticle at every moult.

Juvenoids act at the end of the larval development (pupation and adult formation), so are generally less efficient against all stage larval populations usually found in natural breeding sites. On the other hand, chitin synthesis inhibitors acting at every moult are equally effective against synchronous and asynchronous larval populations. In general, insect growth regulators (IGRs) show a good residual activity and have a high margin of safety for vertebrates, although some adversely affect arthropod non-target species sharing the same habitats of mosquito larvae and should not be used in breeding sites with an abundance of arthropod species.

Photosensitised processes in biological systems have been known for a considerable period of time (Raab, Zeit. Biol. 39: 524-546, 1900; Moan and Peng, Anticancer Res. 23: 3591-3600, 2003). Such processes usually are of oxidative nature, since they involve a highly reactive oxygen species, named singlet oxygen (¹O₂), as the biotoxic intermediate. Singlet oxygen is generated via electronic energy transfer from the photoexcited sensitiser (normally, its long-lived triplet state). The sequence of photophysical and photochemical stages can be schematically presented as follows:

Sens+hv→1Sens promotion of Sens to the first excited singlet state
1Sens→3Sens intersystem crossing to the triplet state
3Sens+O₂→Sens+¹O₂ generation of singlet oxygen via energy transfer
¹O₂+Sub→Sub-ox oxidative attack
Wherein Sens means a visible light-absorbing photosensitising agent.

In general, the photosensitised processes are characterized by a high selectivity in space and time: the short lifetime (in the microsecond range) and high reactivity of singlet oxygen, which can attack a large number of cell constituents, restrict the photooxidative damage to the microenvironment of the site where it is generated. The mean pathway of singlet oxygen in a cell or tissue has been calculated to be shorter than about 0.1 μm (Moan and Peng, 2003).

Photosensitised processes are finding very interesting applications in medicine: a typical example is represented by photodynamic therapy (PDT), which has been originally developed for the treatment of solid tumours (Dougherty et al., J. Natl. Cancer Inst. 90: 889-905, 1998), but is being successfully extended to the treatment of several non-oncological pathologies, in particular, this technique appears to be promising for the treatment of a number of infectious diseases of microbial origin (Joni et al., Lasers Surg. Med. 38: 468-481, 2006).

Porphyrins are able to absorb essentially all the wavelengths of the solar spectrum in the UV and visible range. In particular, porphyrins exhibit an intense absorption band (the Soret band) in the blue spectral region, which represents the most intense component of the sun's emission around midday (Svaasand et al., Proc. SPIE 1203, pp. 2-21, 1990). On the other hand, the red absorption bands of porphyrins are useful at dawn and sunset, when wavelengths longer than 600 nm represent an important component of sunlight.

Several porphyrins yield long-lived triplet states with a high quantum yield >0.7 and therefore are quite efficient photosensitizers. As a rule, the triplet state of porphyrins is efficiently quenched by oxygen. Hence porphyrins typically cause cell inactivation through the generation of singlet oxygen even though radical transfer processes may also be involved (Reddi & Joni, Int. J. Biochem. 25: 1369-1375, 1993). This circumstance enhances the scope and potential of porphyrins as photosensitizers, since they also express a high photoactivity in biological systems even when such systems are characterized by a low oxygen pressure.

The chemical structure of porphyrins can be modified at different levels, including (i) the substituents protruding from the peripheral positions of the pyrrole rings or the meso-carbon atoms, (ii) the metal ions possibly coordinated at the centre of the tetrapyrrolic macrocycle, and (iii) the ligands axial to the metal ion. In this way, it is possible to modulate the physical and chemical properties of the porphyrin molecules and control their partitioning among subcellular or subtissular compartments.

Hydrophobic porphyrins are localized at the level of the cell membranes including the plasma, mitochondrial and lysosomal membranes (Ricchelli & Jori, Photochem. Photobiol. 44: 151-158, 1986). As a consequence, the genetic material is not involved in the photoprocesses leading to cell death. All the available evidence indicates that porphyrin photosensitization of cells does not promote the onset of mutagenic effects, thereby minimizing the risk of selecting photoresistant cell clones.

The extraction and isolation of porphyrins from natural products, and their synthetic preparation (often by modification of natural porphyrins), are relatively simple procedures (Moor et al., Mechanisms of photodynamic therapy. In: Patrice (Ed), Photodynamic Therapy, The Royal Society of Chemistry, Cambridge, 2003, pp. 19-57). The uptake of nanomoles of porphyrin is sufficient to cause a rapid mortality of several types of flies even under moderate intensities of sunlight (Ben Amor et al., Photochem. Photobiol. 71: 123-127, 2000).

Porphyrins often undergo fast photobleaching in sunlight as well as when exposed to artificial visible light sources (Rotomskis et al., J. Photochem. Photobiol. B: Biol. 39: 172-175, 1997).

Several porphyrins are presently used as phototherapeutic agents; toxicological studies (Dougherty et al., 1998) have shown that these dyes in the absence of light induce important damage to humans only upon uptake of at least 100 mg/kg body weight, that is far greater than the amount which is required for generating an extensive toxicity to insects.

Porphyrins of general formula (I):

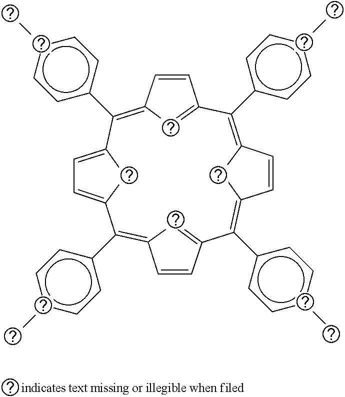

wherein:

### R₁═R₂═R₃ is —CH₃

R₄ can be selected from the group consisting of: —CH₃ (porphyrin T₄MPyP), —CH₂(CH₂)₄CH₃ (porphyrin C₆); —CH₂(CH₂)₈CH₃ (porphyrin C₁₀); —CH₂(CH₂)₁₀CH₃ (porphyrin C₁₂); —CH₂(CH₂)₁₂CH₃ (porphyrin C₁₄); —CH₂(CH₂)₁₆CH₃ (porphyrin C₁₈) or —CH₂(CH₂)₂₀CH₃ (porphyrin C₂₂)
are known in the art (Reddi et al. Photochem. Photobiol., 75, 462-470, 2002; Merchat et al. J. Photochem. Photobiol. B., 32, 153-157, 1996; Maisch et al. Photochem. Photobiol. Sci., 3, 907-917, 2004).

Photosensitised processes have been found appropriate also for controlling the population of noxious insects, including flies (Ben Amor & Joni, Insect Biochem. Mol. Physiol. 30: 915-925, 2000) and mosquitoes of the genera Culex (Dosdall et al., J. Am. Mosq. Control Assoc. 8(2):166-72 1992) and Aedes (Shao et al., J. Photochem. Photobiol., B: Biol., 98: 52-56, 2010; Chen et al. Agric. Sci. China 6(4): 458-465, 2007; Tian et al., J. Nat. Prod. 69: 1241-1244, 2006)

Porphyrin derivatives have been shown to exhibit mosquito larvicidal action on Culex sp. when directly added to larval breeding water in the laboratory (chlorophyllin LD50=6.88 g/l after 3 h exposure to a light intensity of 146.66 W/m², Wohllebe et al., Parasitol. Res. 104: 593-600, 2009) and in semi-field conditions (hematoporphyrin 100% mortality at 10⁻⁵ M after 3 days under natural sunlight Awad et al., J. Agri. Soc. Sci. 4(2): 85-8, 2008). A complete mortality has been reported on Aedes aegypti in laboratory and semi-field experiments by hematoporphyrin derivatives after an exposure to 2.5 g/l for 1 to 6 days (Karunaratne et al., Curr. Sci., 89, 170-173, 2005).

Porphyrins possess several favourable features, such as: property to inactivate both eukaryotic and prokaryotic cells, as well as to promote the killing of bacteria, fungi, and parasitic protozoa in both the cystic and vegetative state, and also of insects in both the larval and adult stages; an efficient phototoxic activity against both wild and antibiotic-resistant microbial strains; the lack of selection of photoresistant cells as a consequence of the multi-target nature of porphyrin-photosensitised processes; a low mutagenic potential; and a high selectivity in killing of pathogens as compared with the main constituents of potential host tissues. Furthermore, porphyrins at the photochemically active doses are devoid of any appreciable intrinsic cytotoxicity in the absence of irradiation.

The use of porphyrins as larvicides is safe for the following reasons: their activity is mediated by visible light, and do not require protective measures for the operators; the products of porphyrin photodegradation do not induce any appreciable toxic or phototoxic effects in a variety of biological systems and their rapid disappearance from the environment strongly reduces the risk of widespread or persistent contamination.

The use of porphyrins as larvicides present the following drawbacks: since porphyrins most likely adhere to a wide range of materials present in natural breeding sites, the application of the molecule in its pure form appears to be a wasteful procedure. In addition, the random environmental dispersal is likely to increase the risk of hitting non-target organisms such as other insects, crustaceans or protozoans.

International Application N. WO97/29637 discloses formulations with photoinsecticidal porphyrins and attractants. Therein, the vehicle is of Sephadex type and establishes a covalent bond with the poprhyrin.

International Application N. WO97/29636 discloses photosensitisers chemically bound to a carrier swelling in water. Here, the carrier is cellulose acetate.

International Application N. WO 90/06955 discloses photosensitizer, including porphyrin, bound to cellulose acetate.

International Application N. WO93/00815 discloses polymer compositions comprising meso-tetra (N-alkyl-4-pyridinium) porphyrin and regenerated cellulose or cellulose diacetate also discloses methylmethacrylate polymerized in solution with protoporphyrin dimethyl ester or other porphyrins.

US Application N. US2004/10245183 discloses haematoporphyrins for the decontamination of polluted water. Also in this case, the carrier is cellulose acetate.

Studies performed in our laboratory about the possible use of a variety of porphyrin carriers for administering such photosensitisers to larvae of Aedes clearly indicates that cellulose acetate is not palatable.

US Application N. 2009/292357 discloses compositions comprising a porphyrin and a methacrylate derivative.

European Patent N. EP 145711 discloses insecticidal agents comprising water soluble porphyrins.

International Application N. WO2003/026646 discloses antimicrobial porphyrins.

US Application N. 2002/0103246 discloses the use of porphyrins to remove bacteria and algae from aquaria.

US Application N. 2005/197324 discloses a bait composition comprising sucrose and meso[tri(N-methylpyridyl), mono(N-dodecyl-pyridyl)]porphine or meso[tri(N-methyl-pyridyl), mono(Ntetradecyl-pyridyl)]porphine.

International Application N. WO 2005/062780 discloses that cat food (pellets) is used to rear mosquito larvae.

US Application N. 2002/065228 discloses bait comprising pesticidal compounds and algae for mosquito larvae.

International Application N. WO2009/149720 discloses a composition comprising a porphyrin derivative being a natural plant extract and an autolysed yeast as a larval feeding attractant for mosquito larvae which is added to the larvae-breeding sites in aqueous solution. Autolysed yeast has been shown to be an attractant for a variety of insects (see Ben Amor T. et al., Photochem. Photobiol. 67: 206-211, 1998; Ben Amor T. et al., Insect Biochem. Mol. Biol. 30: 915-925, 2000).

WO2009/149720 presents inconsistencies and contradictory data or statements.

The porphyrin derivative is defined as being a natural plant extract, however no further details are provided on its composition. Furthermore the porphyrin derivative is defined by abbreviation HP, which means haematoporphyrin and by the value of the molar extinction coefficient which corresponds to haematoporphyrin (Ferro S. et al., Biomacromol. 10, 2592-2600, 2007)

However, porphyrins, including haematoporphyrins, are not present in green plants (Biosynthesis of Tetrapyrroles. P. M. Jordan Ed., Elsevier, Amsterdam, The Netherlands, 1991).

Furthermore, it is stated that the claimed composition exhibits human safety and effectiveness superior to those typical of DDT; however, no comparative results are given.

In addition, in the irradiance measurement, the source of artificial light used is disclosed being an Oriel Corporation Solar simulator equipped with a 1000-Watt Xenon lamp. Said solar simulator contains a high pressure Xenon lamps, hence its emission spectrum is substantially different from the sun emission spectrum.

The quantitative measurements of the porphyrin accumulation in the larvae performed by a spectrofluorimetric procedure are unclear because do not mention any calibration plot demonstrating the relationship between fluorescence intensity and porphyrin concentration.

Moreover, the fluorescence emitted is measured in a wide wavelength range, namely 460-660 nm. Since porphyrins do not emit fluorescence at wavelengths shorter than 580 nm (Moan J. et al. In “Photodynamic Therapy” B. W. Henderson & T. J. Dougherty, eds., Marcel Dekker Inc., pp. 19-36, 1992), collecting data in such a broad wavelength range (460-600 nm) is at a risk of measuring also fluorescence emitted by other biological compounds, such as flavins or bile pigments, rendering the measurements inaccurate.

In addition, the detection of porphyrin in the larvae organism by the spectrofluorimetric technique is carried out using 398 nm or 488 nm as excitation wavelengths without using any control for comparison, e.g. repeating the extraction and spectrofluorimetric procedures for larvae which have not been fed with the porphyrin in order to ascertain and quantify the contribution by non-porphyrin chromophores absorbing these wavelengths (Ben Amor T. et al., Photochem. Photobiol. 67: 206-211, 1998).

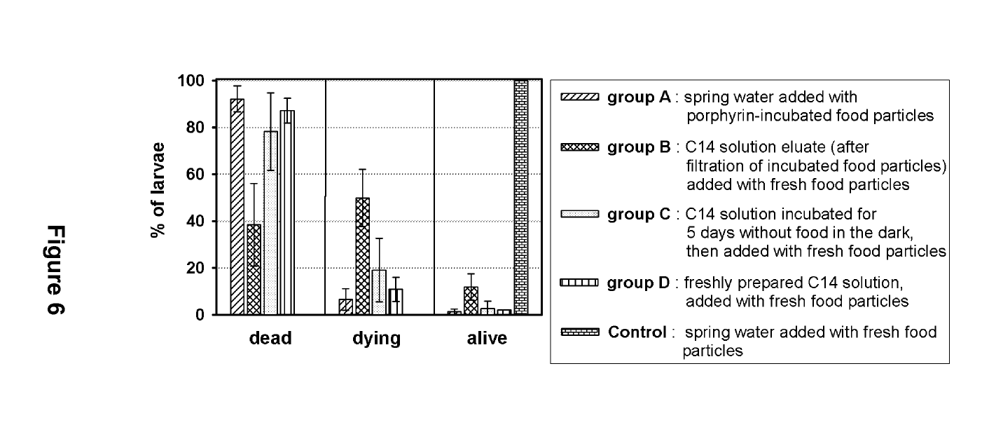

Furthermore, the fluorescence emission spectra reported (FIGS. 9 and 10) are composed of a number of bands, suggesting the presence of a heterogeneous population of emitting species, wherein the emission around 540 nm is originated by a non-porphyrin fluorophor. Usually the presence and relative contribution of porphyrin to the overall emission is obtained by measuring the fluorescence excitation spectra, which proves the exclusive presence of porphyrin in the observed spectral measurement only if they precisely overlap with the porphyrin absorption spectrum (Reddi E. and Jori G., Rev. Chem. Interm. 10, 241-268, 1988)

In the fluorescence lifetime measurements, two values are reported, namely 1.5 ns for short pre-incubation times, and about 15 ns for longer incubation times. The measure of the shorter lifetime is inconsistent with the instrumentation used which has a minimum gate width of 3 ns. Moreover, the use of a monoexponential fitting of the experimental plots does not allow the interpretation of the fluorescence lifetime values in terms of the ratio between monomeric and aggregated porphyrin species, since this piece of information can be necessarily obtained only by using a bi-exponential fitting of the data.

Furthermore, data regarding the decrease in survival of larvae upon exposure to sunlight in the presence of 5×10⁻⁵ M porphyrin are missing.

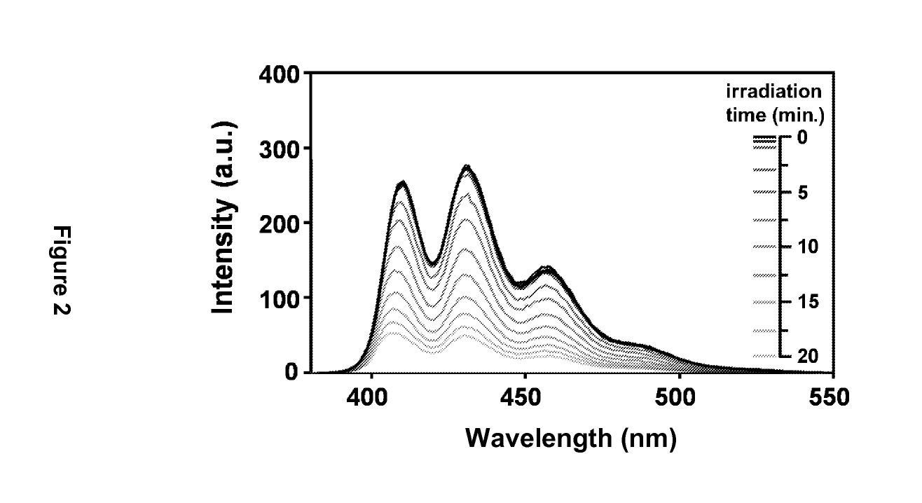

In addition, FIG. 2 reports a porphyrin dose in the x axis of micromoles/ml, that is a millimolar concentration, while the concentrations used in the experiments are reported to be micromolar. Also, the recovery of porphyrin in the y axis is measured as nanomoles of HP/larva, which is an unusual, non-standard and very odd way of measuring such recoveries because various larvae could have different diameter or weight, thus the recovery is generally referred to a more standard value, e.g. the mg of protein or similar parameters (see Ben Amor T. et al., Photochem. Photobiol. 67: 206-211, 1998; Ben Amor T. et al., Insect Biochem. Mol. Biol. 30: 915-925, 2000).

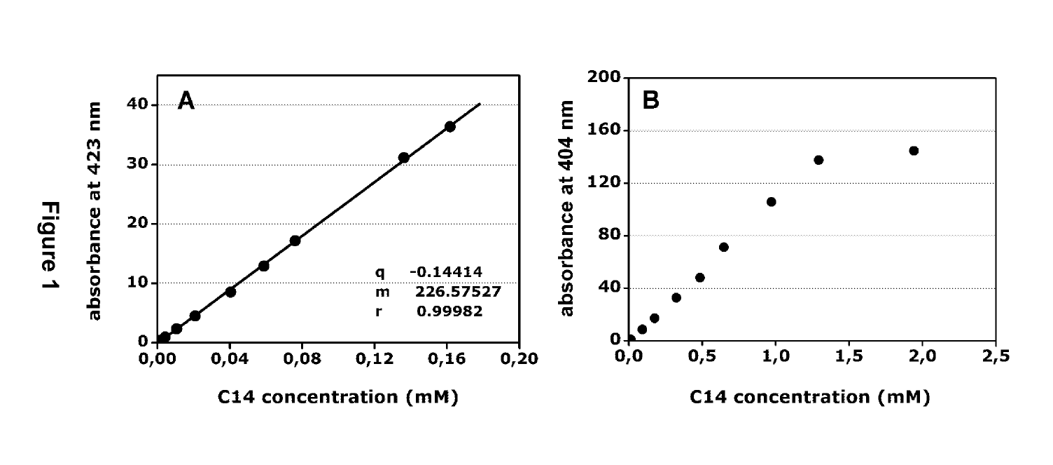

The recoveries reported in FIG. 2 show no effect of the porphyrin concentration in the 1 to 5×10⁻⁵ M range on the uptake of the porphyrin by larvae, this data seem to be in contradiction with the observed effect of porphyrin dose on the decrease in larvae survival in the presence of different porphyrin concentrations, as shown in FIG. 1 where larvae treated with the same range of porphyrin doses exhibit a dose-dependent post-irradiation survival.

Moreover, FIG. 3 points out that the larvae show a measurable residual survival up to 10-20 hours post-irradiation in the presence of 5 micromolar porphyrin, irradiations were performed using fluence-rates of 450 or 650 mW/cm². Said residual survival disagrees with the 100% mortality reported in FIG. 1, using a lower light intensity of 400 mW/cm².

Lastly, other contradictory data are shown in FIG. 11 wherein the 20% residual survival of larvae observed at 2 hours post-irradiation is less than that observed at 10 h post-irradiation, as shown in FIG. 1.

In the International Application N. WO2009/149720 the autolysed yeast is added separately from the porphyrin. The autolysed yeast is used as a generic attractant which equally attracts adult insects, larvae and other organism being present in the same environment. Consequently since porphyrin acts in an unselective manner it becomes dangerous for the environment and the other organisms living therein.

It is the aim of the present invention to provide a larvicide for mosquito vector control being effective against all larval stages of the target organism, having an acceptable residual activity allowing for a sustainable frequency of applications, preferably fortnightly or monthly, being safe for humans, lacking toxicity to non-target arthropods, being biodegradable, being easy to handle and store.

It is also desirable to have a larvicide with low cost and low requirements in terms of application equipment as well as transport conditions.

There is a strongly felt need to provide a formulation which is highly attractive as larval food at an effective dose, considering that in natural breeding sites organic matter, on which usually larvae feed is abundantly available, so that the larvicide formulated must be able to compete with this natural food resource for intake by the larvae.

The formulation should be palatable to mosquito larvae and non-toxic to non-target organisms living in the same environment.

Non-toxicity to non-target organisms is due to the presence of a stable binding between the porphyrin and the carrier forming the larvicide which avoids the release of the photo-insecticidal porphyrin in the aqueous milieu.

The specificity for mosquito larvae is given by the palatability of the complex.

For mosquito larvae preferentially feeding on water surface, the larvicide should keep floating on water surface.

For mosquito larvae preferentially feeding on the bottom, a larvicide floating on water surface is not necessary In the case of a larvicide targeted to Anopheles, its capacity to float increases palatability, in the case of a product targeted to Aedes it depends on the Aedes species but they are more often all round feeders (surface, water column, bottom), most Culex species prefer to feed in the water column (R. W. Merritt et al. Feeding behavior, natural food, and nutritional relationships of larval mosquitoes Annu. Rev_Enlomol. 1992. 37:349-76,).

Palatability is influenced by tastiness, size, and location in the aqueous environment.

Location (floating on the surface/in the water column or sinking) must be taken into account according to the mosquito genus targeted, where tastiness and size are less genus and species specific.

### OBJECT OF THE INVENTION

The above technical problem is solved by the object of the present invention because the carrier and the porphyrins are selected to obtain a larvicide having the desired properties.

The stable complex is obtained because the porphyrin's structure has a cationic head and a carbon tail.

The selected carriers are able to bind to the cationic head of the porphyrin while the carbon tail of the porphyrin forms the hydrophobic external layer of the complex.

The carriers being able to bind to the cationic head of the porphyrin are characterised in having: palatability by larvae, stability in water, presence of a polar matrix with negatively charged groups to interact with the positively charged in the porphyrin molecule.

In a preferred embodiment of the present invention, the porphyrin binding-release characteristics were observed to vary with the pollen species, related to plant species specific protein and glycoprotein composition of the outer grain wall. The ability of the pollen grain to release C12 in the larval intestine after ingestion was found to be species-dependant, as well. The pollen basket types selected for the best performance included pollen grains from the Boraginaceae, Lamiaceae and Brassicaceae families.

An alkaline pre-treatment was carried out on the pollen grains by incubating 8 g of pollen with 960 ml of NH₄OH (0.05 M) for 90 minutes under gentle stirring. At the end of the incubation the material was centrifuged at 800 rpm, washed once with water to eliminate the excess base, and the pellet recovered. The base-treated pollen samples were then incubated in 300 ml of porphyrin C12 solutions (at various concentrations) overnight. At the end of the incubation the samples were centrifuged and washed as described above, and the obtained pollen-base-C12 complexes pellets were lyophilized overnight. The alkaline pre-treatment of pollen carrier was found to significantly increase the larvicidal efficacy of the porphyrin loaded pollen (PO-C12).

In another embodiment of the present invention, Eudragit S100 is an anionic co-polymer, based on methacrylic acid and methyl methacrylate containing —COOH groups. The polymer is insoluble in aqueous media, is permeable and has pH dependent release profile. Eud S100 is soluble above pH 7.0. It is widely used for targeted delivery in the ileum and is enabled for pH-dependent release of the active ingredient. Binding of porphyrin on Eud S100, is based on conjugation of the ligand with its positive charge and hydrophobic chain (C12) to the reversibly soluble-insoluble polymer, controlling the solubility of latter by varying the pH of medium. This feature is only possible if the polymer has either charges or a combination of charges and hydrophobic groups as reported for Eud S100. The product was easily prepared and the yield of preparation and entrapment efficiencies were very high also with smaller particle size. According to the results of spectroscopic investigation no drug interaction occurred between polymer and porphyrin.

The protein-rich fraction (protein content 80%, fat 10%, carbohydrates, minerals and vitamins 10%) from a commercial cat food pellet preparation (Friskies®) (named CF) is selected because it is enriched in anionic moieties, such as tyrosine or aspartate rich proteins (typically present in food products designated to young animals) so that the porphyrin molecule will adhere to such carriers with its cationic “head”, whereas its long carbon tail will stand off, forming a hydrophobic external layer on the coated particle.

As above explained the carrier is not simply anionic but should contribute to the overall structure so that the so-obtained complex is stable in the aqueous milieu and, if needed, is able to float on water surface, where larvae of certain species preferentially feed.

Floating capacity is influenced also by the overall diameter of the larvicide, the diameter of the carrier particles, the concentration of porphyrin in the loading solution and the porphyrin dosage within the complex.

Another feature influencing palatability is the overall diameter of the larvicide, it should be no bigger than that of food particles typically ingested by such larvae at different stages of their development, that is smaller than 100 microns, preferably 5-20 microns.

Moreover, since the pH in the anterior intestine of said larvae is alkaline (pH >8), the carrier should be stable at neutral and acid pHs to avoid the release of the porphyrin and should release the porphyrin at alkaline pH. As a consequence, once ingested by larvae, the porphyrin dissociates from the carrier and localizes in various segments of the larvae alimentary canal, inducing a marked degree of photosensitivity and eventual death of the larvae owing to extensive damage of the gastrointestinal apparatus.

A mixture of natural and synthetic carriers according to the present invention are also provided and such a mixture is within the term “carrier” used herein.

In view of the above, the object of the present invention is a composition comprising at least one porphyrin and at least one carrier which are stably, non-covalently associated by means of (a) electrostatic interactions between the cationic functional groups of the porphyrin molecule and the anionic groups in the polar matrix of the carrier; and (b) hydrophobic interactions between the hydrocarbon tail of the porphyrin molecule and lipid domains of the carrier and wherein the carrier is selectively palatable by mosquito larvae, with the proviso that the carrier is not autolysed yeast.

It is also an object of the present invention a composition comprising at least one porphyrin and at least one carrier which are stably, non-covalently associated by means of electrostatic and hydrophobic interactions and wherein the carrier is selectively palatable by mosquito larvae, with the proviso that the carrier is not autolysed yeast, wherein the porphyrin and the carrier are in the form of a complex.

It is an object of the present invention a composition comprising at least one porphyrin and at least one carrier which are stably, non-covalently associated by means of electrostatic and hydrophobic interactions, optionally in the form of a complex, wherein the carrier is selectively palatable by mosquito larvae, said carrier not being autolysed yeast, wherein the carrier is stably associated with the porphyrin at temperatures below 50° C., and for pH values ranging from 5.0 to 8.0

It is an object of the present invention a composition comprising at least one porphyrin and at least one carrier which are stably, non-covalently associated by means of electrostatic and hydrophobic interactions, optionally in the form of a complex, wherein the carrier is selectively palatable by mosquito larvae, said carrier not being autolysed yeast, wherein the carrier is stably associated with the porphyrin in dryness, at a temperature below 50° C. and relative humidity up to 80%.

It is an object of the present invention a composition comprising at least one porphyrin and at least one carrier which are stably, non-covalently associated by means of electrostatic and hydrophobic interactions, optionally in the form of a complex, wherein the carrier is selectively palatable by mosquito larvae, said carrier not being autolysed yeast, wherein the carrier is stably associated with the porphyrin for at least 1 month, preferably at least 3 months, more preferably at least 6 months in storage conditions.

It is an object of the present invention a composition comprising at least one porphyrin and at least one carrier which are stably, non-covalently associated by means of electrostatic and hydrophobic interactions, optionally in the form of a complex, wherein the carrier is selectively palatable by mosquito larvae, said carrier not being autolysed yeast, wherein the carrier is stably associated with the porphyrin for at least 2 weeks in water.

In a further object of the present invention, the carrier in the composition has a diameter between 5 μm and 50 μm.

In the composition object of the present invention, the carrier may be synthetic or natural.

In the composition object of the present invention, the synthetic carrier may be selected from the group consisting of Eudragit, methacrylate derivatives, polyvinylpyrrolidone, PEG derivatives; liposomes, polypeptides, oligo- or poly-saccharides, starch, amylopectin, Ca++/alginate, poly(lactic acid) (PLA) optionally conjugated with polyethylene glycol (PEG) or their co-polymers, poly(lactic-co-glycolic acid) (PLGA) optionally conjugated with polyethylene glycol or their co-polymers, functionalized polyethylene glycols, polysaccharides, dextranes, poly(acrylic acid) (PAA), poly(acrylic acid) (PAA) co-polymers, poly(vinyl alcohol) (PVA), poly(vinyl alcohol) (PVA)co-polymers, poly(ethylene oxide), poly(ethylene oxide) co-polymers, poloxamers, poloxamers co-polymers, polyethyleneimine (PEI), polyethyleneimine (PEI) co-polymers.

In the composition object of the present invention, the natural carrier may be selected from the group consisting of pellet food for carnivorous animals, pellet food for herbivorous animals, vegetable coal, pollen, vegetable flours, and seeds.

In a further object of the present invention, the carrier is Eudragit.

In a further object of the present invention, the carrier is pollen.

In further object of the present invention, the carrier is cat or mouse pellet food.

In a further object of the present invention, the carrier is the protein-rich fraction (protein content 80%, fat 10%, carbohydrates, minerals and vitamins 10%) from a commercial cat food pellet.

In still another object of the present invention, the porphyrin is of formula (I):

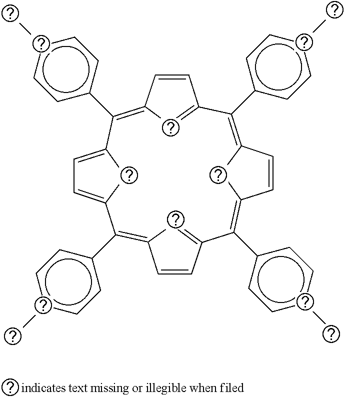

wherein:

### R₁═R₂═R₃ is —CH₃

R₄ is a straight or branched C₁-C₂₂ hydrocarbon chain,
all the possible stereoisomers, Z and E isomers, optical isomers and their mixtures,

In still another object of the present invention, R₄ is a straight or branched, saturated or unsaturated, C₁-C₂₂ alkyl chain.

In still another object of the present invention, R₄ is selected form the group consisting of: —CH₃, —CH₂(CH₂)₄—CH₃; —CH₂(CH₂)₈CH₃; —CH₂(CH₂)₁₀CH₃; —CH₂(CH₂)₁₂CH₃; —CH₂(CH₂)₁₆CH₃ or —CH₂₀(CH₂)₈CH₃.

In still another object of the present invention, R₄ is —CH₂(CH₂)₁₀CH₃ or —CH₂(CH₂)₁₂CH₃.

It is a further object of the present invention a composition comprising meso-tri(N-methyl-pyridyl), mono(N-dodecyl-pyridyl)porphine and Eudragit.

It is still a further object of the present invention a composition comprising meso-tri(N-methyl-pyridyl), mono(N-tetradecyl-pyridyl)porphine and Eudragit.

It is another object of the present invention a composition comprising meso-tri(N-methyl-pyridyl), mono(N-dodecyl-pyridyl)porphine and pollen.

It is still a further object of the present invention a composition comprising meso-tri(N-methyl-pyridyl), mono(N-tetradecyl-pyridyl)porphine and pollen.

It is another object of the present invention a composition comprising meso-tri(N-methyl-pyridyl), mono(N-dodecyl-pyridyl)porphine and cat or mouse pellet food.

It is still a further object of the present invention a composition comprising meso-tri(N-methyl-pyridyl), mono(N-tetradecyl-pyridyl)porphine and cat or mouse pellet food.

It is another object of the present invention a composition comprising meso-tri(N-methyl-pyridyl), mono(N-dodecyl-pyridyl)porphine and a protein-rich fraction (protein content 80%, fat 10%, carbohydrates, minerals and vitamins 10%) from a commercial cat food pellet.

It is still a further object of the present invention a composition comprising meso-tri(N-methyl-pyridyl), mono(N-tetradecyl-pyridyl)porphine and a protein-rich fraction (protein content 80%, fat 10%, carbohydrates, minerals and vitamins 10%) from a commercial cat food pellet.

It is also an object of the present invention the use of the composition as a larvicide, preferably against mosquitoes of the genus Aedes or Anopheles and more preferably against Aedes aegypti, Anopheles gambiae, Anopheles arabiensis, Anopheles stephensi, Aedes albopictus.

A further object of the present invention is a larvae food formulation comprising said composition.

It is also an object of the present invention a method for controlling larvae development comprising feeding larvae with said larvae food formulation.

It is also an object of the present invention a method for controlling larvae development comprising applying in the environment the composition and the kit thereof which comprises suitable means for applying said composition or said food formulation in the environment.

The above methods according to the present invention comprises the steps of feeding mosquito larvae or applying in the environment the composition or the food formulation of the present invention and exposing or let to be exposed said larvae to a light source suitable for activating porphyrin.

Sunlight is a suitable light source.

Unlike compounds acting by direct contact with the target, the composition object of the present invention is selective and larvae-specific since it exerts his larvicidal effect by ingestion and for this reason is less prone to affect non-target organisms.

In the composition of the present invention the porphyrin and the carrier interact by means of electrostatic and hydrophobic interactions.

For the above reason the combination of the present invention, wherein porphyrin and carrier interact, is specifically ingested by larvae.

Cationic porphyrins which interact with the negatively charged carboxylate groups which are present at the outer surface of cell membranes of mosquito larvae through an ionic binding are more efficient as larvicide, since they allow for a real time electrostatically driven association between the photosensitising agent and the larvae organism.

The porphyrins of formula (I) effectively interact with the negatively charged carboxylate groups which are present at the outer surface of endothelial cell membranes of mosquito larvae through an electrostatic interaction and the hydrocarbon tail localized at the periphery of the porphyrin molecule favours the anchoring of the porphyrin itself to the lipid domains of cell membranes in the intestine of the target organism, increasing the stability of the complex between the photosensitising agent and the target organism are much more efficient as larvicide.

In the composition of the present invention, the carrier is designed in terms of physical properties (e.g. particle diameter, capability to float) and chemical characteristics (e.g. attractiveness as food) in order to match with the behavioural features and physiological needs of the targeted mosquito larvae, that vary according to the mosquito species (Merritt et al., Annu. Rev. Entomol. 37: 349-376, 1992).

Furthermore, in the composition of the present invention, the carrier protects porphyrin against light-induced and hydrolytic degradation, allows floating on water surface and helps its solubilisation in media with pH >8.

Additionally, in the composition of the present invention the carrier is attractive for larvae, is workable to produce microparticles of controlled particle diameter and is bioinert.

The present invention is safe for humans, easy to handle and store and has low cost and low requirements in terms of application equipment as well as transport conditions.

The present invention is biologically effective against the target organism, including residual activity, lack of toxicity to non-target organisms and is able to control synchronous and asynchronous larval populations made of larvae.

The present invention provides also a cheap larvicide with low requirements in terms of application equipment as well as transport conditions, appropriate to a production and application in low income countries affected by mosquito born diseases.

Further features and characteristics of the present invention would be clear from the following detailed description and examples, with reference to the figures wherein:

FIG. 1 shows the effect of concentration on the absorbance of C14 porphyrin solutions, wherein solutions were prepared in PBS. Panel A shows the absorbance of solutions at the maximum of the Soret band (424 nm). Panel B shows the absorbance at a wavelength characterized by a lower molar extinction coefficient (404 nm).

FIG. 2 shows the efficiency of singlet oxygen generation by photoactivated C14 porphyrin. Effect of the irradiation time (up to 20 min) on the fluorescence properties of a DMA solution (initial absorbance around 1 at 380 nm) and porphyrin solution (initial absorbance around 0.4 at 420 nm) in N,N-dimethyl-formamide (DMF), which was exposed to white light (400-800 nm) at a fluence rate of 100 mW/cm².

FIG. 3 shows the adsorption and release dynamics of C14 on mouse food particles (particle diameter 5-500 μm). Panel A shows the residual concentration of C14 (5 μM) in the aqueous medium as a function of incubation time at 28±2° C. in the presence (▪) and in absence () of food particles: clearly, the concentration of porphyrin rapidly decreases in the presence of the particles because of adsorption on their surface. Panel B shows the stability of the C14-loaded food particles in C14-free buffer solutions, as a function of incubation time at various pH values. C14 appeared to remain stably associated with food particles. Specifically, the C14 concentrations in the incubation buffers ranged from 0.01 μM (pH 7.0) to 0.024 μM (pH 9.5), corresponding to a release of just 2.14%-5.15% of the initial C14 amount.

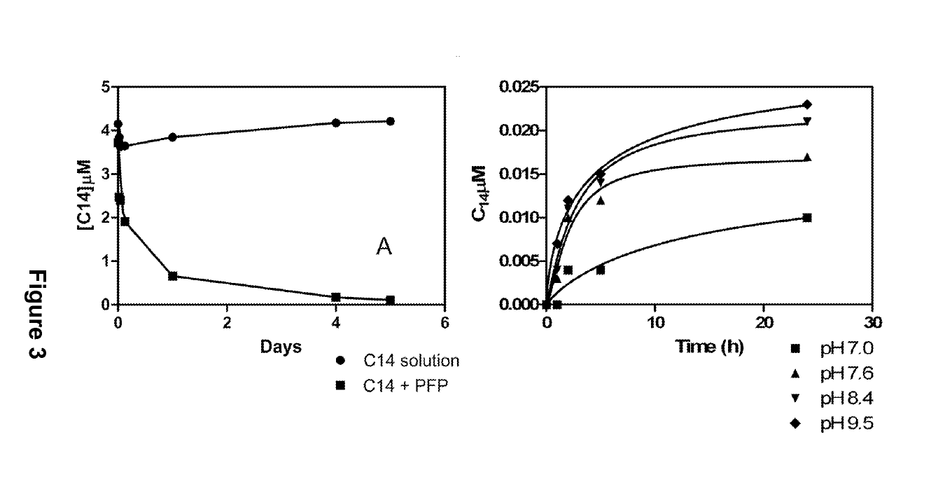

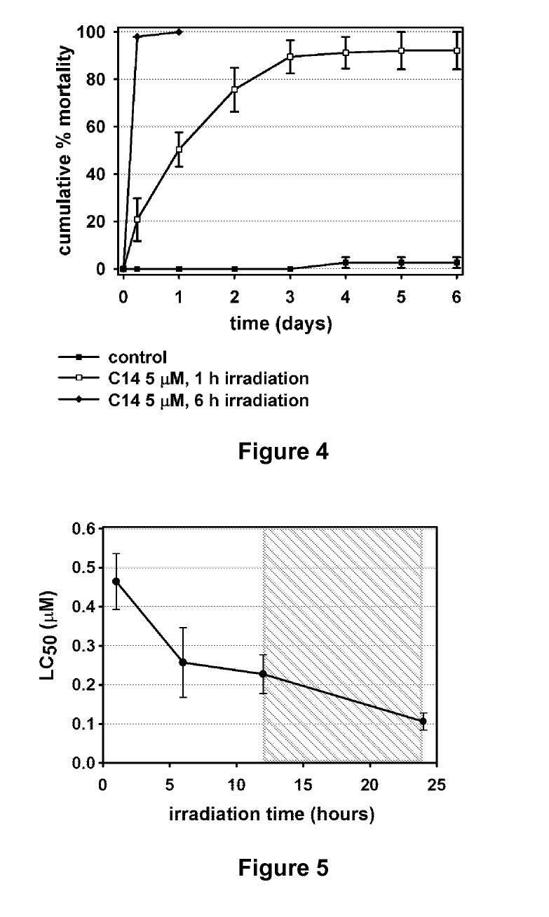

FIG. 4 shows the larvicidal photosensitizing effect of C14 porphyrin. Mortality of Aedes aegypti larvae (n=50) incubated with C14 at 28±2° C. in the dark for 12 hours, and then exposed to light (fluence rate 1.0-4.0 mW/cm²) for 1 or 6 hours. After the irradiation period, larvae were kept in the dark and larval mortality was monitored for 6 days. Arithmetic means of percentages of dead larvae. Error bars represent standard deviations (n=3 replicates of 50 larvae each).

FIG. 5 shows the influence of irradiation time on C14 porphyrin median lethal concentration (LC50) on 3rd-early 4th instar A. aegypti larvae. Error bars represent 95% confidence intervals (n=3 replicates of 100 larvae each). The shaded area in the graph indicates the period of incubation without light (night).

FIG. 6 shows the effect of different incubation conditions of PFP with 5 μM C14 porphyrin solutions on larvicidal activity against A. aegypti. Food particles (70 mg) were added at the time of introduction of the larvae (n=50, see methods for details). Arithmetic means of percent dead, dying and living larvae after 3 hours irradiation (intensity 1.0-4.0 mW/cm²). Error bars represent standard deviations, (n=3 replicates of 50 larvae each).

### DETAILED DESCRIPTION OF THE INVENTION

### Definitions

Within the scope of the present invention:

Carrier is a food particle for mosquito larvae which is able to non-covalently bind to the porphyrin.

Complex means a covalent or non-covalent association between two molecules or chemical units.

In specific embodiments, the term complex means the structure formed by the non-covalent association of a porphyrin with a carrier by means of electrostatic and hydrophobic interaction wherein the carrier binds to the cationic head of the porphyrin while the carbon tail of the porphyrin forms the hydrophobic external layer of the complex.

Porphyrin means free base porphyrin derivatives, metal-substituted porphyrin derivatives, and tetrapyrrole analogues of porphyrins, all bearing from 0 to 8 peripheral substituents on the pyrrole rings and from 0 to 4 substituents in the meso positions (K. M. Smith. “Porphyrins and Metalloporphyrins”, Elsevier, Amsterdam, 1975).

Tetrapyrrole analogues of porphyrins means chlorins, porphycenes, phthalocyanines and naphthalocyanines.

Porphyrin C₁₂ means meso-tri(N-methyl-pyridyl), mono(N-dodecyl-pyridyl)porphine.

Porphyrin C₁₄ means meso-tri(N-methyl-pyridyl), mono(N-tetradecyl-pyridyl)porphine.

Por-Eud means the composition including Eudragit polymer and porphyrin.

Synthetic carrier means a carrier prepared by chemical synthesis.

Natural carrier means a carrier of natural origin obtained by extraction and/or purification processes.

Eudragit® S 100 (Evonik Industries AG, Essen, Germany) means an anionic co-polymer, based on methacrylic acid and methyl methacrylate. Eudragit® S 100 is used in pharmaceutics as a drug carrier for oral treatments (Na & Bae: pH-sensitive polymers for drug delivery. In: Polymeric drug delivery systems. G. S. Kwon (Ed.). Taylor & Francis, Boca Raton, USA, Vol. 148, pagg. 135-139 (2005).

Palatability means being attractive as food for target mosquito larvae, being able to match with behavioural features and physiological needs of the target mosquito larvae, being able to compete with natural occurring organic matter usually eaten by larvae to be selectively ingested by targeted mosquito larvae.

Storage conditions means storage in closed containers, preferably in tightly sealed vials, under anhydrous conditions, with protection from light via darkened or non-transparent material in or around the container walls, under constant temperature, preferably at 20° C.

Food formulation means particles of mouse or cat food prepared in suitable size to be ingested by larvae.

The present inventors herein demonstrated that
1) the composition of the present invention is effective as mosquito larvicide against several mosquito species belonging to two different genera, namely Aedes aegypti, Anopheles gambiae (both S and M chromosomal forms), An. arabiensis and An. stephensi. The tested compositions act on mosquito laboratory reared larvae as well as on larvae collected from natural breeding sites (tables 2 and 3).
2) The composition of the present invention acts on the larvae after ingestion through the exposure of the porphyrin-fed larvae to light (table 4).
3) The composition of the present invention is readily up-taken by all larval instars (table 5), while porphyrins alone if dissolved in water as such, in the absence of a carrier, exhibit photo-toxic effects on non-target organisms of aqueous habitats (table 7).
4) Yeasts, powdered cereals or beans, and ornamental fish food were found to easily absorb porphyrin and to be readily ingested by Anopheles larvae. However, the formulates were not able to float for more than a couple of hours. Vegetal oil-porphyrin emulsions and porphyrin-loaded liposomes met the criteria of floatability, but were uneatable by larvae. Pet food pellets, pollen and Eudragit were found to possess the desired properties.
5) Cat food-C12 and pollen-C12 formulates proved to be stable in water from larvae breeding sites; to be palatable by Anopheles larvae and competitive with natural food resources, to float on water surface for at least one week and to be effective against major malaria vector species, namely Anopheles stephensi, A. arabiensis, A. gambiae.
6) Non-target microorganisms were not affected by the photocidal preparations at doses of the porphyrin-carrier complex inducing a high larval mortality, and this is a consequence of the lack of significant porphyrin release by the formulate into aqueous media.
7) No residual activity of formulates was found after 24 h of direct sunlight exposure, but a 2-5 day residual activity was observed in conditions of indirect light exposure (cloudy weather, shaded positions).
8) Comparing the results with data available for microbial larvicides based on Bacillus thuringiensis var. israelensis (Vectobac) and Bacillus sphaericus (Vectolex, ValentBioScience), our sunlight-activated prototypes appear to have a similar efficacy. Indeed, the microbial products were shown to control A. gambiae larvae at a dose of 20-100 mg/m² (Fillinger et al., Trop Med Int Health 2003), and the 2 prototype photocidal formulates reduced larval densities (A. gambiae, A. arabiensis) by 83-100% at a porphyrin dose of 40-60 mg/m².

The porphyrin may be selected from the group consisting of free base porphyrin derivatives, metal-substituted porphyrin derivatives, and tetrapyrrole analogues of porphyrins, all bearing from 0 to 8 peripheral substituents on the pyrrole rings and from 0 to 4 substituents in the meso positions.

Teetrapyrrole analogues of porphyrins may be selected from the group consisting of chlorins, porphycenes, phthalocyanines and naphthalocyanines

In a first preferred embodiment the porphyrin is cationic.

In a further preferred embodiment of the present invention, the porphyrin has the following formula (I):

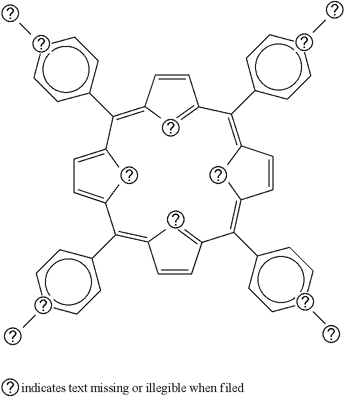

wherein:

### R₁═R₂═R₃ is —CH₃

R₄ is a straight or branched C₁-C₂₂ hydrocarbon chain.

Preferably R₄ is a straight or branched, saturated or unsaturated, C₁-C₂₂ alkyl chain.

More preferably R₄ is selected form the group consisting of: —CH₃ (porphyrin T₄MPyP), —CH₂(CH₂)₄—CH₃ (porphyrin C₆); —CH₂(CH₂)₈CH₃ (porphyrin C₁₀); —CH₂(CH₂)₁₀CH₃ (porphyrin C₁₂); —CH₂(CH₂)₁₂CH₃ (porphyrin C₁₄); —CH₂(CH₂)₁₆CH₃ (porphyrin C₁₈) or —CH₂₀(CH₂)₈CH₃ (porphyrin C₂₂).

Most preferably R₄ is —CH₂(CH₂)₁₀CH₃ or —CH₂(CH₂)₁₂CH₃.

The invention includes within its scope all the possible stereoisomers, Z and E isomers, optical isomers and their mixtures of compounds of formula (I).

Preferred porphyrins of formula (I) are:

meso-tri(N-methyl-pyridyl), mono(N-dodecyl-pyridyl)porphine;
and, meso-tri(N-methyl-pyridyl), mono(N-tetradecyl-pyridyl)porphine.

Porphyrins of formula (I) are characterized by the presence of four positively charged functional groups selected from the group consisting of pyridine rings inserted in the four meso positions of the tetrapyrrolic macrocycle, the nitrogen atom of each pyridyl ring being quaternarized and made cationic by the binding of three methyl groups and a hydrocarbon chain. Said functional groups interact with the negatively charged carboxylate groups which are present at the outer surface of cell membranes of mosquito larvae through an electrostatic interaction. Moreover, the hydrocarbon tail localized at the periphery of the porphyrin molecule favours the anchoring of the porphyrin itself to the lipid domains of cell membranes in the target organism, increasing the stability of the complex between the photosensitising agent and the target organism.

In a further preferred embodiment Porphyrin C₁₂ and Porphyrin C₁₄ (Frontier Scientific, USA) were used.

In the composition of the present invention, a suitable carrier, irrespectively of being a synthetic or natural carrier, should have the following the characteristics:

Chemical properties: capability to establish a stable, non-covalent association with porphyrins by means of the presence of negative or positive charges, assuring the electrostatic interaction with the positively or, respectively, negatively charged groups in the porphyrin molecule. Moreover, thanks to the presence of the hydrophobic aromatic macrocycle, porphyrins can associate with the core of the polymer chain by hydrophobic interactions.

Physical properties: capability to remain stably associated with porphyrins in water over a broad range of physical and chemical conditions, such as temperature below 50° C. and pH 5.0 to 8.0, reflecting the conditions of natural breeding sites, as well as in dryness, such as temperature below 50° C., relative humidity up to 80%, reflecting the possible extreme storage conditions. Capability to remain stably associated with porphyrins for at least 6 months in storage conditions, and for at least 2 weeks in water.

Biological properties: capability to produce, once loaded with porphyrins, a residual larvicidal activity of up to 2 weeks; palatability by mosquito larvae and competitiveness with natural occurring organic matter usually eaten by larvae; diameter between 5 μm and 50 μm; capability to reach a homogeneous distribution in defined zones of the water column, specifically, in relation with the larval feeding behaviour of the various species of mosquito, e.g. floating on the surface, distributing throughout the water column, or settling at the bottom; lack of toxicity on non-target vertebrate and invertebrate species at the typical doses of field application; lack of contact, ingestion and inhalation toxicity on humans during production, handling, storage, transport and application.

The synthetic carriers can be selected from the group consisting of Eudragit®, methacrylate derivatives, polyvinylpyrrolidone, PEG derivatives; liposomes, polypeptides, oligo- or poly-saccharides, starch, amylopectin, Ca⁺⁺/alginate, poly(lactic acid) (PLA) optionally conjugated with polyethylene glycol (PEG) or their co-polymers, poly(lactic-co-glycolic acid) (PLGA) optionally conjugated with polyethylene glycol or their co-polymers, functionalized polyethylene glycols, polysaccharides, cellulose derivatives, dextranes, dextranes co-polymers, poly(acrylic acid) (PAA), poly(acrylic acid) (PAA) co-polymers, poly(vinyl alcohol) (PVA), poly(vinyl alcohol) (PVA)co-polymers, poly(ethylene oxide), poly(ethylene oxide) co-polymers, poloxamers, poloxamers co-polymers, polyethyleneimine (PEI), polyethyleneimine (PEI) co-polymers. By the terms “derivatives”, “functionalized” and “co-polymers” it is herein intended to refer to a range of products which are available in the art of pharmaceutical, food and agrochemical fields. The term “derivatives” is intended to derivatives of the compound which the term refers to, which are commonly known in the art. The term “functionalized” is intended to refer to the compound which the term refers to, which is modified through chemical reactions in order to change its physico-chemical properties in order to render it more suitable to the intended scope, for example improving solubility or dispersibility, and so on. The term “co-polymers” is perfectly understood by the person of ordinary skill in the art and is intended to those co-polymers of common use and available in the above mentioned technical-fields.

Examples of natural carriers are pellet food for carnivorous or herbivorous animals, vegetable coal, pollen, vegetable flours, seeds.

In an embodiment of the present invention the synthetic carrier is Eudragit®.

In another embodiment of the present invention Eudragit is Eudragit S100®.

In another embodiment of the present invention the natural carrier is mouse or cat food pellets.

In a further embodiment of the present invention the synthetic carrier is the protein-rich fraction (protein content 80%, fat 10%, carbohydrates, minerals and vitamins 10%) from a commercial cat food pellet preparation (Friskies®).

In another embodiment of the present invention the synthetic carrier is pollen, preferably pollen from plants belonging to several families (Boraginaceae, Lamiaceae, Brassicaceae).

In a further preferred embodiment, when treating Anopheles larvae which preferentially ingest food particles floating on water surface, a carrier being able to float on water surface is selected.

In still a further preferred embodiment, when treating Aedes aegypti larvae which feed on the bottom, it is not necessary to select a carrier floating on water surface.

The efficacy and selectivity of the ingestion of the claimed composition by Anopheles and Aedes larvae are achieved by taking care that the diameter of the formulate is not bigger than that of food particles typically ingested by such larvae at the different stages of their development, that is smaller than 100 microns, preferably 5-20 microns, furthermore taking advantage of the fact that pH in the anterior intestine of such larvae is naturally alkaline (pH >8), matching with the chemical characteristics of the Eudragit polymer that at alkaline pH conditions unfolds, releasing the porphyrin: as a consequence, once ingested by Anopheles larvae, the porphyrin dissociates from the carrier and localizes in various segments of the larvae alimentary canal, inducing a marked degree of photosensitivity and eventual death of the larvae owing to extensive damage of the gastrointestinal apparatus. Moreover, Eudragit® is stable at neutral and acid pHs, hence porphyrin will not be released in the aqueous environment of typical natural breeding sites and also it will not be released and act in other small organisms, characterized by neutral or acid intestinal pH.

Experimental evidences are provided using compositions comprising porphyrin C₁₂ or porphyrin C₁₄ and Eudragit® or mouse or cat food pellets.

### EXAMPLES

### Example 1

### Efficacy as Mosquito Larvicide

Laboratory strains of Anopheles stephensi, M and S (Kisumu), chromosomal forms of An. gambiae, An. arabiensis and Aedes aegypti, as well as field-collected Anopheles spp. and Aedes spp. larvae were used. Laboratory mosquitoes were maintained at 28-30° C., >90% RH and a photoperiod of 12 h. Light intensity ranged between 0.5 mW/cm² (fluorescent lamp) and 185 mW/cm² (sunlight).

C₁₂ or C₁₄ porphyrin solutions at 5-100 μM concentrations were pre-incubated at room temperature in the darkness with 15-60 mg of carrier (either Eudragit or ground mouse food or cat food) for 4-12 hours under gentle shaking. After incubation the solutions were filtered, and the loaded carrier was dried at room temperature or in an oven (45° C.).

Eudragit was Eudragit S100® (Evonik Industries AG, Essen, Germany).

The binding efficacy of porphyrin to Eudragit is about 95%, with respect to the initial quantity of porphyrin dissolved in the incubation solution. For example, incubation of 25 mg Eudragit in 10 ml of 50 μM porphyrin (C₁₂) yields a Por-Eud (wherein Por means porphyrin C12 and Eud means Eudragit S100® (Evonik Industries AG, Essen, Germany) formulate containing 18.6 μg porphyrin per mg of Eudragit. The used compositions were stable for at least one month in the dark after their preparation.

One litre capacity, transparent plastic trays containing wells with each 500 ml water and 6-60 mg of the composition of the present invention were prepared. Batches of 60-100 L2, L3 or L4 larvae were introduced into the trays after sunset (or artificial light off). Larval mortality was evaluated the next day starting from 8.00 am, and the time required to reach at least 90% mortality was recorded. Larvae not moving or not showing an escaping response at probing were defined as dead or dying, and counted together (Tables 2 and 3). Pupae occasionally formed throughout the irradiation time were discarded and excluded from the evaluation. An equal number of batches of larvae prepared in the same way were kept in continuous darkness and mortality was evaluated similarly, to assess toxicity in the dark.

Table 2 shows the efficacy as mosquito larvicide of C₁₂ and C₁₄ of the composition comprising porphyrin and the carrier being Eudragit or mouse or cat food pellets in tests performed at a laboratory scale, wherein 60-100 larvae/500 ml per tray; larvae were allowed to feed on the formulations overnight; each result derives from an independent, representative experiment. Light intensity range: 0.5-185 mW/cm².

TABLE 2

| Laboratory | | | amount | loading | | Time to reach |
|---|---|---|---|---|---|---|
| reared mosquito | | | (mg) per | concentration | | ≧90% |
| species, strains | compound | carrier | tray | (μM) | light source | mortality (hrs) |
| Anopheles | C12 | Eudragit | 60 | 50 | sun | 0.5 |
| gambiae Kisumu | | | 30 | 50 | sun | 0.5 |
| strain (S) | | | 15 | 50 | sun | 0.5 |
| | | | 30 | 25 | sun | 0.5 |
| | | | 15 | 25 | sun | 0.5 |
| An. arabiensis | C12 | Eudragit | 30 | 50 | sun | 0.5 |
| | | | 15 | 5 | sun | 3 |
| An. gambiae (M) | C12 | Eudragit | 15 | 25 | sun | 0.5 |
| An. gambiae | C12 | cat food | 60 | 100 | sun | 0.5 |
| Kisumu strain (S) | | | 30 | 100 | sun | 0.5 |
| | | | 30 | 50 | sun | 0.5 |
| | | | 30 | 25 | sun | 8 |
| An. arabiensis | C12 | cat food | 30 | 50 | sun | 3 |
| An. gambiae (M) | C12 | cat food | 30 | 50 | sun | 3 |
| Aedes aegypti | C14 | mouse | 70 | 5 | fluorescent | 3 |
| | | food | | | lamp | |
| An. stephensi | C12 | mouse | 6 | 0.64 | fluorescent | 6 |
| | | food | | | lamp | |
| An. stephensi | C14 | mouse | 6 | 0.5 | fluorescent | 1 |
| | | food | | | lamp | |

Table 3 shows the efficacy on field-collected mosquitoes wherein 60-100 larvae/500 ml per tray; larvae were allowed to feed on the C12 formulates overnight; no dark toxicity was observed. Each result derives from an independent, representative experiment. Light source: sunlight in all cases, intensity range: 4-185 mW/cm²

TABLE 3

| | | amount | loading | Time to |
|---|---|---|---|---|
| Field collected | | (mg) per | concentration | reach ≧90% |
| specimen | carrier | tray | (μM) | mortality (hours) |
| Anopheles spp + | Eudragit | 30 | 50 | 0.5 |
| Aedes spp | | | | |
| Anopheles spp | Eudragit | 30 | 25 | 0.5 |
| Anopheles spp | Eudragit | 15 | 15 | 3 |
| Anopheles spp | cat food | 30 | 50 | 3 |

The results of tables 2 and 3 show that loading a synthetic or natural carrier, palatable for mosquito larvae, with porphyrin derivatives results in an effective larvicidal formulation leading to 100% larval mortality in a short time (typically 0.5 to 3 hours). Laboratory strains of the genera Anopheles and Aedes, as well as field collected larvae belonging to the same genera, show similar susceptibility. The doses applied, when expressed as g/ha of active principle, appear to be in the same range as the field dosages for the currently WHO recommended larvicides. For instance, 500 ml of water treated with 15 mg C12Por-Eud that has been loaded with C12 at 50 μM corresponds roughly to a dosage of 400 g/ha of C12 (see Table 1). Incubating Eudragit in a 10 times less concentrated solution of C12, and using 15 mg of this Por-Eud resulted in a slower killing of the larvae that however exceeded 90% in just 3 hours.

### Example 2

### Ingestion of Por-Eud by Larvae and Photosensitizing Effect of the Ingested Formulate

The photosensitizing effect of ingested Por-Eud, wherein Por means porphyrin C12 and Eud means Eudragit S100® (Evonik Industries AG, Essen, Germany), on mosquito larvae was demonstrated in experiments conducted in the laboratory using Anopheles gambiae Kisumu strain, all larval stages and the results are shown in table 4. Larvae were fed overnight with untreated Eudragit (Eud control) or with porphyrin-loaded Eudragit and then exposed to sunlight. Treated larvae were exposed to light either in the same tray where the overnight feeding occurred (Por-Eud), or after being transferred to trays containing clean water (Por-Eud tray change). Additionally, a batch of larvae was added to filtered water from trays that were incubated overnight with Por-Eud (Por-Eud water).

Table 4 shows the mortality of larvae fed with Por-Eud overnight and exposed to sunlight in Por-Eud treated water trays or in trays containing clean water.

TABLE 4

| | Larval mortality after | Larval mortality after 30 |
|---|---|---|
| | overnight incubation, | min exposure to |
| Treatments | performed in the dark | sunlight (70 mW/cm²) |
| Eud control | 0% | 0% |
| Por-Eud | 0% | 100% |
| Por-Eud tray change | 0% | 100% |
| Por-Eud water | 0% | 5% |

The data shows that Por-Eud does not cause any larval mortality when trays are kept in the dark, while larvae incubated overnight with Por-Eud and transferred to clean water for light exposure die after 30 min of light exposure, underlining the circumstance that the Por-Eud action is related to the formulate ingestion. Only a low mortality was observed when larvae were incubated in filtered Por-Eud water, which was probably due to small Por-Eud particles having passed through the filter.

### Example 3

### Larval Instars Uptake of Porphyrin Loaded on a Carrier

Direct observations were made under the stereomicroscope of An. stephensi and Ae. aegypti larvae fed with porphyrin loaded on animal pellets, being mouse and cat food (Mucedola Srl, Italy and Friskies®) or Eudragit, being Eudragit S100® (Evonik Industries AG, Essen, Germany).

Anopheles stephensi and Aedes aegypti larvae in all stages of larval development were offered porphyrin loaded on animal pellets or Eudragit, both containing particles of different diameter (1-300 μm). An. stephensi larvae ingest preferentially food particles floating on water surface, while Aedes larvae feed on the bottom of the containers. Larvae take up preferably particles in the range of 20-50 μm. Examining larvae guts at the microscope revealed that the majority of the particles visible in the gut lumen measure between 6 and 20 μm. The difference in particle range observed at uptake and within the gut might be explained by a break down or digestion of the food taken up.

### Example 4

### Attractiveness of Porphyrin Loaded on an Organic Carrier Vs. Untreated Carrier as Food Resource

In order to evaluate the attractiveness of porphyrin coated food particles taking into account that in natural environments a porphyrin larvicide must compete with natural food particles, porphyrin-treated animal food pellet (Por-AFP), wherein Por means porphyrin C12 and AFP means Animal Food Pellet being mouse and cat food (Mucedola Srl, Italy and Friskies®), was offered to larvae mixing it with different amounts of untreated AFP, wherein AFP means Animal Food Pellet being mouse and cat food (Mucedola Srl, Italy and Friskies®).

The following mixtures were tested: Por-AFP:AFP=1:0, 0:1, 1:1, 1:5, 1:15, 1:45.

Experiments were performed with larvae of different developmental stages using Anopheles stephensi and Aedes aegypti. Larvae were fed with the mixtures for 30 minutes, then the guts were observed under the fluorescence microscope. The density of porphyrin particles in the guts of larvae that had fed on mixtures of Por-AFP:AFP=1:15 and 1:45 was found to correspond to the proportion of porphyrin particles in the food mixture, indicating that larvae do not have any positive or negative preference for porphyrin coated particles. In larvae that fed on the Por-AFP:AFP=1:1 and 1:5, a relatively higher intensity of red fluorescence than expected was observed, probably due to some porphyrin diameter having gone in solution, colouring all the food bolus.

### Example 5

### Effects on Non-Target Organisms of Aqueous Habitats

The effect of free porphyrin, wherein porphyrin means porphyrin C12, dissolved in water on the photosensitivity of potential aqueous non-target organisms was evaluated on Colpoda inflata, Artemia franciscana and Daphnia magna, a protozoan and two crustacean organisms frequently found in aqueous environments. The mortality data were recorded after 1 h irradiation with visible light emitted by a fluorescent lamp. The results are shown in table 5.

TABLE 5

| Non-target | | Porphyrin dose | | LD-50 |
|---|---|---|---|---|
| organism | Specific example | (μM) | Mortality (%) | (μM) |
| Protozoa | Colpoda inflata | 0.6 | 40 | 1.0 |
| | (trophozoites) | | | |
| | Colpoda inflata | 1.0 | 20 | >1.0 |
| | (cysts) | | | |
| Crustacean | Artemia | 6.0 | 20 | >10.0 |
| | franciscana | | | |
| | Daphnia magna | 0.3 | 50 | 0.3 |

The above results show that said invertebrates can be affected by the photocidal action of free porphyrin dissolved in water.

### Example 6

### Pollen Selection

A bee pollen product (pollen baskets) containing pollen grains from different plant species, belonging to several families, was tested for porphyrin C12 loading, floatability, palatability.

The porphyrin binding-release characteristics were observed to vary with the pollen species, most likely related to plant species specific protein and glycoprotein composition of the outer grain wall. The ability of the pollen grain to release C12 in the larval intestine after ingestion was found to be species-dependant, as well. The pollen basket types selected for the best performance included pollen grains from the Boraginaceae, Lamiaceae and Brassicaceae families.

An alkaline pre-treatment was carried out on the pollen grains by incubating 8 g of pollen with 960 ml of NI-140H (0.05 M) for 90 minutes under gentle stirring. At the end of the incubation, the material was centrifuged at 800 rpm, washed once with water to eliminate the excess base, and the pellet recovered. The base-treated pollen samples were then incubated in 300 ml of porphyrin C12 solutions (at various concentrations) overnight. At the end of the incubation the samples were centrifuged and washed as described above, and the obtained pollen-base-C12 complexes pellets were lyophilized overnight. The alkaline pre-treatment of pollen carrier was found to significantly increase the larvicidal efficacy of the porphyrin loaded pollen (PO-C12).

PO-C12 demonstrated an excellent film-like dispersion property on water surface and the grains, varying in diameter between 5 and 50 μm were observed to be readily ingested by larvae of different developmental stages.

PO-C12 wherein pollen was from plants belonging to several families (Boraginaceae, Lamiaceae, Brassicaceae) and porphyrin was porphyrin C12, was then used in all the further experiments.

### Example 7

### Floatability

the floatability of Porphyrin-carrier, wherein Porphyrin means porphyrin C12, was tested with a series of potential carriers in order to evaluate if it keeps floating on water surface, where Anopheles larvae preferentially feed.

The potential carriers tested were yeasts, powdered cereals or beans, Animal Food pellet (being mouse and cat food Mucedola Srl, Italy and Friskies®)), pollen and Eudragit (wherein Eudragit means Eudragit S100 (Evonik Industries AG, Essen, Germany)) and ornamental fish food Mucedola Srl, Italy and Friskies®.

PO-C12 was found to float for several days (>5 days) independently on the porphyrin concentration used in the loading solution, whereas in the case of CF-C12 and EU-C12 formulates, the capacity to remain on the surface was found to be influenced by the concentration of the porphyrin loading solutions, improving significantly with increasing molarity of the solution. Particle diameter also appeared to affect floatability of CF-C12 and Eudragit-C12 complexes. Thus, in order to maximize floatability, the 3 carrier candidates were loaded with 0.5 mM porphyrin solutions, a concentration which yields porphyrin saturated complexes. Floatability was evaluated for a period of 2 weeks, measuring the amount of particles remaining on the surface by image analysis (Axiovision V.4.8.1.0, Carl Zeiss imaging solutions GmbH). For CF-C12 and EU-C12 a fine fraction (particles size <180 μM) and a coarse fraction (particle diameter >180 uM) were separately examined. After one week of incubation, 90% or more of the PO-C12 and CF-C12 formulate fine fraction was found to be still present on the surface. With the coarse fraction particles of CF-12, a 100% floatability was recorded even after 2 weeks of incubation. The floatability of EU-C12 also, resulted to be related to particle diameter: after 1 week, 80% of coarse fraction particles were located on the surface compared to 20% of fine fraction particles. These results show that the synthetic porphyrin molecule itself is key to design floatable formulates. By selecting as carriers, substances enriched in anionic moieties, such as tyrosine or aspartate rich proteins (typically present in food products designated to young animals), the porphyrin molecule will adhere to such carriers with its cationic “head”, whereas its long carbon tail will stand off, forming a hydrophobic external layer on the coated particle.

The result showed that yeasts, powdered cereals or beans, and ornamental fish food (Tetramin®) were readily ingested by Anopheles larvae, however they were not able to float for more than a couple of hours.

The result showed that Pollen, Animal Food pellet and Eudragit® (Evonik Industries AG, Essen, Germany) possess the desired floatability (table 6).

TABLE 6
Floatabilitiy of porphyrin complexes

| | % of complexes | % of complexes |
|---|---|---|
| | floating | floating |
| | after 1 week | after 2 weeks |
| | incubation | incubation |
| Pollen - C12 | 90 | 60 |
| CF-C12 fine fraction* | 90 | 65 |
| CF-C12 coarse | 100 | 100 |
| fraction** | | |
| EU-C12 fine fraction | 20 | 10 |
| EU-C12 coarse | 80 | 75 |
| fraction | | |

*particles' size < 180 μm;
**particles' size > 180 μm

### Example 8

### Carrier Optimization

By using as the carrier the protein-rich fraction (protein content 80%, fat 10%, carbohydrates, minerals and vitamins 10%) from a commercial cat food (CF) pellet preparation (Friskies®), herein named (CF), microparticles loaded with porphyrin C12 were prepared (named CF-C12).

Porphyrin-loaded pollen grains were prepared (PO-C12), wherein pollen was from plants belonging to several families (Boraginaceae, Lamiaceae, Brassicaceae) and porphyrin was porphyrin C12.

PO-C12 demonstrated an excellent film-like dispersion on water surface. The grains with a diameter of 5-50 μm were readily ingested by larvae at different developmental stages.

The porphyrin binding efficiency depended on the pollen species, most likely related to different protein compositions of the outer grain wall.

Por-Eud (wherein Por means porphyrin C12 and Eud means Eudragit S100® (Evonik Industries AG, Essen, Germany)), was found to be stable at neutral and acid pH, but, due to molecular unfolding induced by an alkaline environment, it easily released the porphyrin moiety of the complex at pH >8. This implies that the photosensitizer is not released from a Por-Eud in typical natural breeding sites (pH 6.5-7.5), nor in the digestive tract of organisms having neutral or acid intestinal pH, but is released in the gastric caeca of mosquito larvae, characterized by a pH ranging in the 9-10 interval.

### Example 9

### Formulate Stability

The effect of incubation time on the stability C12-carrier complexes, wherein C12 means porphyrin C12, was evaluated in source water and water from three typical larvae breeding sites in Burkina Faso. The concentration of free porphyrin released into the water as well as the amount of porphyrin bound to the carrier was studied by spectrophotometric analysis. The data obtained clearly show that the CF-C12 complex (wherein CF means protein-rich fraction (protein content 80%, fat 10%, carbohydrates, minerals and vitamins 10%) from a commercial cat food (CF) pellet preparation (Friskies®) and C12 means porphyrin C12), is very stable: indeed, not traces of photosensitizer were released in all types of water until at least 48 h from the beginning of incubation. Moreover, the amount of porphyrin bound per mg of cat food micro-pellets appears to be unchanged over time (up to 1 week) after introduction of the complex in the water: the efficiency of porphyrin recovery was closely similar to that obtained before incubation never decreasing below 90% of the initially measured value.

In the case of PO-C12 complex (wherein PO means pollen from plants belonging to Boraginaceae, Lamiaceae, Brassicaceae and C12 means porphyrin C12) traces or a weak release of porphyrin (0.12±0.03 μM) were observed already after 1 hour incubation in the waters from the larvae breeding sites. No increase of free C12 concentration was recorded during the subsequent hours. In the case of source water, higher values of porphyrin (1.82±0.1 μM) were detected at all incubation times. A modification in the protocol of preparation of the C12 pollen complex (drying instead of lyophilization) allowed a complete inhibition of the porphyrin release. The C12 content per mg of pollen complex appears to be very stable over time: a recovery of about 90% of the initial value was registered at 48 hours from the introduction in all types of water.

The stability of Por-Eud (wherein Por means porphyrin C12 and Eud means Eudragit S100 (Evonik Industries AG, Essen, Germany)) was examined after incubation in source water: the complex appeared to be stable and no porphyrin traces were detected until at least 48 hours.

Moreover, with the aim to determine the level of degradation of the free porphyrin in the water after exposure to sunlight, the rate of C12 photo-bleaching was followed spectrophotometrically by measuring the porphyrin absorption spectrum in the 350-700 nm range upon exposure to visible light at a fluence rate of 150 mW/cm². After 1 hour irradiation the porphyrin concentration decreased up to 50%. This result could minimize the side effects of released porphyrin to non-target organisms.

### Example 10

### Capacity to Float

The PO-C12 complex (wherein PO means pollen from plants belonging to Boraginaceae, Lamiaceae, Brassicaceae and C12 means porphyrin C12) was still floating 5 days after its dispersion in water, independently of the bound porphyrin concentration. In the case of CF-C12 (wherein CF means protein-rich fraction (protein content 80%, fat 10%, carbohydrates, minerals and vitamins 10%) from a commercial cat food (CF) pellet preparation (Friskies®) and C12 means porphyrin C12) and Eud-C12 (wherein Eud means Eudragit S100® (Evonik Industries AG, Essen, Germany) and C12 means porphyrin C12), persistence at water surface significantly increased upon increasing the amount of bound porphyrin and the particle diameter. To define the carrier properties which maximize floatability, the 3 candidates were loaded with 0.5 mM porphyrin, a concentration which yields porphyrin-saturated complexes.

Floatability was evaluated for a period of 2 weeks, by measuring the amount of floating particles through image analysis (Axiovision V.4.8.1.0, Carl Zeiss imaging solutions GmbH). A coarse fraction (particles diameter >180 μm) of CF-C12 and EU-C12 displayed maximal floatability (100% and 80% particles at water surface after 1 week, respectively). Fine fractions (particles' diameter <180 μm) of CF-C12 and EU-C12 gave a surface recovery at 1 week of 90% and 20%, respectively. The PO-C12 complex showed a 90% floatability under the same experimental conditions.

### Example 11

### Palatability

Food choice experiments were carried out in order to evaluate palatability. Porphirin alone was found to be as attractive for A. stephensi larvae as the larval food routinely used in the insectary. When offering to larvae Por-AFP (wherein Por means porphyrin C12 and AFP means Animal Food Pellet being mouse and cat food), AFP alone, or mixtures of both at different proportions (1:1, 1:5, 1:15, 1:45), not any feeding preference was observed. The examination of larval intestines at the fluorescent microscope (porphyrin emits light in the red spectrum when excited at 450-490 nm), revealed the same proportions of porphyrin loaded particles (red) versus unloaded particles (greenish) in the food bolus as in the offered food mixture.

The attractiveness of the CF-C12, PO-C12 and Eud-C12 (wherein CF means protein-rich fraction (protein content 80%, fat 10%, carbohydrates, minerals and vitamins 10%) from a commercial cat food (CF) pellet preparation (Friskies®), PO means pollen from plants belonging to Boraginaceae, Lamiaceae, Brassicaceae, Eud means Eudragit S100® (Evonik Industries AG, Essen, Germany) and C12 means porphyrin C12) was assessed, by determining the speed of formulate uptake. Starved larvae were allowed to feed on CF-C12, PO-C12, EU-C12 or on the unloaded carriers. Every 5 minutes, samples of larvae (n=30) were removed from the treatment and control trays and examined under the microscope, recording the proportion of intestinal tract filled up with porphyrin formulates or carrier. CF-C12 and PO-C12 were found to be taken up quickly and as readily as the unloaded CF and PO preparations. Within 10 minutes, almost all examined larvae displayed the gastric caecum and midgut filled up with the formulates or carriers. EU-C12 appeared to be relatively less attractive for A. stephensi larvae, to obtain 50% feeding, 20 min of incubation with the formulate particles was required.

### Example 12

### Efficacy Under Insectary Conditions

Experiments were performed at standard insectary conditions (Methods in Anopheles Research Manual. http://www.mr4.org/Portals/3/Pdfs/ProtocolBook/MethodsAnophelesResearchV4c.pdf). In particular, mosquito cultures and laboratory bioassays took place in a climatic chamber kept at 30±2° C., RH ≧90%. Irradiation at a fluence rate of 1.0-4.0 mW/cm², full spectrum visible light (400-800 nm) from fluorescent lamps, was regulated over a photoperiod of 12 hours darkness, 12 hours light.

The following combinations were used:

CF-C12 (wherein CF means protein-rich fraction (protein content 80%, fat 10%, carbohydrates, minerals and vitamins 10%) from a commercial cat food (CF) pellet preparation (Friskies®) and C12 means porphyrin C12) with C12 concentrations ranging from 0.5 μM to 500 μM; two fractions of the 500 μM CF-C12 combination were used: a fine fraction <180 μm and a coarse fraction >180 μM particle diameter; PO-C12 (wherein PO means pollen from plants belonging to Boraginaceae, Lamiaceae, Brassicaceae, and C12 means porphyrin C12) loaded with 500 μM C12; Eud-C12 (wherein Eud means Eudragit S100 (Evonik Industries AG, Essen, Germany) and C12 means porphyrin C12) loaded with C12 concentrations ranging from 0.5 μM to 500 μM.

Early efficacy studies showed that the porphyrin photosensitizer causes an extensive death of A. stephensi larvae within few hours from exposure, even at very low concentrations. In a dose-efficacy bioassay, a MEC₅₀ (Minimal Effective Concentration) of 0.5 μM porphyrin was recorded when larvae were kept overnight with porphyrin-loaded food particles and then exposed to insectary light for 12 hours. Notably, these data were obtained under insectary light conditions, i.e. at 1.0-4.0 mW/cm², a fluence rate which is 50-100 times lower than that of natural sunlight at Sub-Saharan latitudes.

In a dose-efficacy bioassay, larval mortalities ≧95% were observed within 36 hours of light exposure with all formulates at the lowest tested dose of 1-2 mg/tray. The CF-C12 fine fraction was found to kill larvae more rapidly than the coarse fraction and PO-C12. At a dosage of 6 mg, a ≧95% mortality was recorded after 10-15 h exposure with the CF-C12 fine fraction, compared to 15-19 hours with the latter two formulates.

Fluorescence microscope analyses revealed that the ingested, photo-activated porphyrin affects peritrophic matrix and epithelium integrity in both the gastric caeca and midgut section of the intestine. Porphyrin-treated larvae show amorphous dilatations in these parts and the intestinal content appears to have diffused to the extra-peritrophic space. For comparison, the intestines of larvae fed on untreated food exhibit regular and smooth wall lining. Interestingly, porphyrin appears to be able to enter epithelial cells independently of being photo-activated: larvae overnight fed on CF-C12 and strictly kept in the dark, display intracellular porphyrin aggregations in the gastric caeca and mid-gut epithelium. This feature explains the rapidity of photo-killing of specimen and underlines the importance to focus efficacy optimisation on the binding-release characteristics of the C12-carrier complex. No mortality or damaging effects were observed upon dark-incubation of the larvae with the C12 formulates for up to 48 hours.

### Example 13

### Toxicity to Non-Target Organisms

The dark- and photo-toxic activity of free C12 (wherein C12 means porphyrin C12) was tested on representative components of mosquito's breeding sites biota, the results are shown in table 6, as minimal photosensitizing dose (μM). Porphyrin exhibited a significant affinity for all these organisms (1 h incubation, 0.1-10.0 μM dose range) and fluorescence microscopy showed that the porphyrin was promptly accumulated, even by Colpoda inflate cysts. Sensitivity to phototreatment (visible light, 10 mW/cm²) was obviously different, as C. inflate trophozoites and even cysts were highly photosensitive, while Artemia franciscana nauplii appeared to be highly resistant. Overall, these results indicate that the stability of the carrier-porphyrin complex is critical to minimize the potential damage to the ecosystem where Anopheles larvae thrive.

TABLE 7

| | | | |
|---|---|---|---|
| PROTOZOA | Colpoda inflata | cysts | 0.6 |
| | Colpoda inflata | vegetative cells | 0.3 |
| | Tetrahymena thermophila | vegetative cells | 3.0 |
| CHLOROPHYTA | Chlamydomonas reinhardtii | vegetative cells | 0.2 |
| CRUSTACEA | Daphnia magna | young individuals | 0.3 |
| | Artemia franciscana | nauplii | >10.0 |

### Example 14

### Efficacy Under Field-Oriented Experimental Conditions

Three porphyrin formulates, namely CF-C12 (wherein CF means protein-rich fraction (protein content 80%, fat 10%, carbohydrates, minerals and vitamins 10%) from a commercial cat food (CF) pellet preparation (Friskies®) and C12 means porphyrin C12), PO-C12 (wherein PO means pollen from plants belonging to Boraginaceae, Lamiaceae, Brassicaceae, and C12 means porphyrin C12) and Eud-C12 (wherein Eud means Eudragit S100 (Evonik Industries AG, Essen, Germany) and C12 means porphyrin C12), were effective in outdoor tray experiments, against both laboratory reared and field collected specimen of A. arabiensis and A. gambiae.

In order to overcome the competition by natural food present in stagnant waters (e.g. microalgae and bacteria), the porphyrin dosage was increased to 500 μM, which in addition guaranteed a high floatability of the particles in water.

Bioassays were carried out by exposing 60 larvae per tray (500 ml water) to formulates at 7.5-60 mg/tray.

The strongest larvicidal activity was displayed by Eud-C12, which caused a complete mortality of all Anopheles strains at doses lower than 25 μM within 8 hours of exposure to sunlight. However, this formulation had to be dropped since its palatability was too low to compete with natural food. On the other hand, satisfactory results, in terms of both efficacy and palatability, were obtained with CF-C12: 100% mortality after 8 hours sunlight exposure, with a 50 μM C12 ‘loading dose’, and 30 mg formulate per tray.

Since Anopheles larvae are preferentially surface feeders, the competitiveness of C12 formulates with respect to ‘natural’ food is markedly affected by the degree of micropellet hydration. Formulates loaded with a porphyrin dose of 500 μM, to enhance hydration thanks to the high C12 hydrophilicity, proved to float for more than a week and to be as palatable as standard insectary larval food. Therefore, the following formulates, all loaded with 500 μM porphyrin, were chosen for experiments in waters from breeding sites: CF-C12 fine (particles diameter <180 μm), CF-C12 coarse (particles diameter >180 μm) and PO-C12 (5-50 μm).

The porphyrin dosage was increased to 500 μM in order to overcome the competition by natural food present in stagnant waters (e.g. microalgae and bacteria), which in addition guaranteed a high floatability of the particles in water.

Overnight feeding of larvae with CF-C12 (30 mg/tray) followed by sunlight exposure in the morning, caused a 100% mortality within 3.5 hours for all the tested Anopheles specimens, with the exception of coarse CF-C12 in Diébougou waters. The PO-C12 (10 mg/tray), offered to larvae in early morning, also caused an extensive mortality (>90% within 7.5 hours of sunlight exposure). Once again, a lower efficacy was observed in Diébougou waters. The results are shown in table 8.

TABLE 8

| | | | | (sunlight | | | |
|---|---|---|---|---|---|---|---|
| | Breeding | % Mortality | | exposure) | | | |
| Formulate | site water | A. gambiae | | A. arabiensis | | Field collected larvae | |
| CF-C12 | Vallée du Kou | 100 | (3.5 h) | 100 | (3.5 h) | 100 | (3.5 h) |
| fine | Koa | 100 | (3.5 h) | 100 | (3.5 h) | 100 | (3.5 h) |
| | Diébougou | 100 | (3.5 h) | 100 | (3.5 h) | 100 | (3.5 h) |
| CF-C12 | Vallée du Kou | 100 | (3.5 h) | 58-100¹ | (3.5 h) | 96-100 | (3.5 h) |
| coarse | Koa | 100 | (3.5 h) | 83-100 | (3.5 h) | 100 | (3.5 h) |
| | Diébougou | 5-80 | (7.5 h) | 23-68 | (7.5 h) | 64-90 | (7.5 h) |
| PO-C12 | Vallée du Kou | 48-96 | (7.5 h) | 40-96 | (7.5 h) | 59-90 | (7.5 h) |
| | Koa | 18-99 | (7.5 h) | 88-94 | (7.5 h) | 94-95 | (7.5 h) |
| | Diébougou | 20-71 | (7.5 h) | 0-33 | (7.5 h) | 76-77 | (7.5 h) |

¹Upper and lower limit percentages represent means obtained from duplicate trays of 2 experiments

### Example 15

### Residual Activity

The formulates studied were CF-C12 fine, CF-C12 coarse (wherein CF means protein-rich fraction (protein content 80%, fat 10%, carbohydrates, minerals and vitamins 10%) from a commercial cat food (CF) pellet preparation (Friskies®), C12 means porphyrin C12, fine means particles diameter <180 μm and coarse means particles diameter >180 μm) and PO-C12 (wherein PO means pollen from plants belonging to Boraginaceae, Lamiaceae, Brassicaceae, and C12 means porphyrin C12) at a concentration of 500 μM. The efficacy of the compositions in inducing larval mortality was assessed by adding the larvae (60 per tray) to trays containing the three compositions which had been exposed to direct sunlight under different climatic conditions for 0 to 5 days.

The above formulates are gradually photobleached upon exposure to sunlight; the extent of the process depends on the intensity of the incident light.

Exposed to direct sunlight, the 3 formulates were 100% active only on the day of application. After 1 day, the killing efficacy was reduced to one third with CF-C12 fine and PO-C12, and absent with CF-C12 coarse. However, when the formulates were exposed to light intensities of 1-9 mW/cm², corresponding to cloudy weather conditions or shaded positions, a residual efficacy of up to 5 days was observed with PO-C12, of 2 days with CF-C12 fine and 1 day with CF-C12 coarse.

### Example 16

### Efficacy in Small Scale Field Experiments

A preliminary, small scale field experiment (wherein small scale field experiment means an experiment performed in a specific area of Vallée du Kou, an endemic malaria site, using a limited (16) number of ponds colonized by larvae) was conducted in April/May 2011 in an irrigated rice cultivation area in Vallée du Kou (Burkina Faso). The selected area was an uncultivated field, crossed by a streamlet near to a village. The wet, muddy soil was dug by the inhabitants to prepare bricks for house construction, leaving sort of pits that got rapidly infiltrated with streamlet water and colonized by Anopheles mosquitoes. Next to these “natural”, man-made breeding sites, 20 “experimental” brick pits of about 1 m² surface area each were prepared and the experiment started when 16 holes were found positive for Anopheles larvae. Since larval density was low, 1000 larvae (stage 2 and 3), reared from field collected Anopheles females, were added to each pit. Groups of 4 pits were treated with 1 g of CF-C12 fine, CF-C12 coarse, PO-C12 or unloaded CF as control (wherein CF means protein-rich fraction (protein content 80%, fat 10%, carbohydrates, minerals and vitamins 10%) from a commercial cat food (CF) pellet preparation (Friskies®), C12 means porphyrin C12, fine means particles diameter <180 μm, coarse means particles diameter >180 μm and PO means pollen from plants belonging to Boraginaceae, Lamiaceae, Brassicaceae). Larval densities were monitored daily at dusk, by dipping (6 dips with a 250 ml cup) and counting larvae (stage 1, 2, 3, 4) and pupae. Counts at day 1, after about 10 h of light exposure, confirmed rapid larvicidal action of CF-C12 fine and PO-C12 formulate, with larval mean counts of 13 (CI₉₅ 5-32) and 26 (CI₉₅ 1-501), respectively, compared to 181 (CI₉₅ 126-260) in controls, which corresponds to reductions >85%. For unexplained reasons, PO-C12 was completely inactive in one out of the 4 treated pits (this explains the upper limit of the CI₉₅ confidence interval (CI) of 95% for this formulate). The coarse fraction of CF-C12 did not reduce larval densities. Possibly, the relatively large particles of this formulate attracted other organisms feeding on organic substances, such as non-culicinae insects and tadpoles.

### Example 17

### Toxicity to Non-Target Organisms in the Field

Water samples collected in mosquito breeding sites were analysed at the light microscope to identify the main biotic components. The microscopic community included bacteria, cyanobacteria and green algae (prokaryotic, having no nuclei or other discrete cellular organelles), algae (both motile and non-motile, unicellular and multicellular), slime moulds, protozoa and some small metazoa. Apparently, the number of these organisms varied in the different sites.

Samples of pool water were observed after overnight incubation with 0.5 mM CF-C12 or PO-C12 complexes (wherein CF means protein-rich fraction (protein content 80%, fat 10%, carbohydrates, minerals and vitamins 10%) from a commercial cat food (CF) pellet preparation (Friskies®), C12 means porphyrin C12 and PO means pollen from plants belonging to Boraginaceae, Lamiaceae, Brassicaceae). All the observed organisms appeared to be unaffected in their morphological traits, behaviour, and survival, by the exposure to the formulates, which therefore do not appear to be intrinsically toxic or damaging for the larval ecosystem.

### Example 18

### Photophysical and Photochemical Studies

### Photostability of C14 Porphyrin in Aqueous Medium

C14 means synthetic cationic porphyrin, meso-tri(N-methylpyridyl), meso-mono(N-tetradecylpyridyl)porphine tetrasulphonate (MW=1545.96).

The photostability of the C14 porphyrin was determined in phosphate-buffered saline (PBS) upon illumination of a 2.5 μM porphyrin solution (initial absorbance around 0.5 at 424 nm) with white light (400-800 nm), which was isolated from the emission of a quartz-halogen lamp equipped with broad band filters to eliminate UV and infrared radiation. The light source was supplied by Teclas (Lugano, Switzerland), and operated at a fluence rate of 20 mW/cm². During irradiation the porphyrin solution was kept in agitation on a magnetic stirrer at room temperature. The concentration of the porphyrin in the aqueous solution was monitored spectrophotometrically at different irradiation times up to 60 min, and the photostability was expressed as the percent residual absorbance referred to the absorbance measured before irradiation.

### Determination of Singlet Oxygen Quantum Yield

The potential of the C14 porphyrin as a photosensitising agent was assessed on the basis of the quantum yield (φΔ) of singlet oxygen (¹O₂) generation by the photoexcited triplet state of the porphyrin, namely the number of ¹O₂ molecules generated per number of absorbed light photons. In the present study φΔ was measured by following the decrease in the fluorescence emission of 9,10-dimethyl-anthracene (DMA) upon its photosensitised conversion into the corresponding non-fluorescent 9,10-endoperoxide. The reaction of singlet oxygen with DMA occurs with 100% chemical quenching (no competing physical quenching), hence the amount of DMA modified in the reaction also provides information on the quantitative yield of singlet oxygen generation (Gross E, Ehrenberg B, Johnson F M (1993) Singlet oxygen generation by porphyrins and the kinetics of 9,10-dimethylanthracene photosensitization in liposomes. Photochem Photobiol 57: 808-813). In a typical experiment, a DMA solution (1.5 ml, initial absorbance around 1 at 380 nm) and porphyrin solution (1.5 ml, initial absorbance around 0.4 at 420 nm) in N,N-dimethyl-formamide (DMF) were placed in a quartz cuvette with a 1 cm optical path and irradiated with 400-800 nm light wavelengths (Teclas lamp, 100 mW cm-2) at 20° C.±2° C. under gentle magnetic stirring for different periods of time up to 20 min. The DMA fluorescence emission was recorded in the 380-550 nm wavelength range with excitation at 360 nm. The first-order rate constant of the photoprocess was obtained by plotting In F0/F as a function of the irradiation time t, where F0 and F represent the fluorescence intensity at time 0 and time t, respectively. The slope of the linear plot thus obtained allowed the rate constant of the photoprocess to be calculated. The constant was then converted into ¹O₂ quantum yield by comparison with the rate constant for DMA photooxidation sensitized by C1 porphyrin, which was used as a reference compound, being an analogue of C14, with a methyl group in place of the tetradecyl chain. The φΔ of the C1 porphyrin was shown to be 0.51 (Reddi E, Ceccon M, Valduga G, Jon G, Bommer J C, et al. (2002) Photophysical properties and antibacterial activity of meso-substituted cationic porphyrins. Photochem Photobiol 75: 462-470).

When dissolved in neutral aqueous solution, the C14 porphyrin exhibited the typical absorption spectrum of meso-substituted porphyrin derivatives, and in particular the maximum absorbance of the intense Soret band was located at 424 nm. To test the possible occurrence of aggregation processes for this porphyrin, the intensity of the Soret band was titrated as a function of the porphyrin concentration according to the Beer-Lambert law. In a first phase of our investigations, the data were calculated up to a porphyrin concentration of 0.16 mM (FIG. 1A), since the optical density of more concentrated porphyrin solutions became too large even using cuvettes of 0.1 cm optical path. While the strictly linear plot would indicate that C14 exists in a purely monomeric state up to 0.16 mM in aqueous solution, an attentive observation of the shape of the absorption spectrum (data not shown) suggests that a slight shoulder on the shorter wavelength side of the C14 Soret band appears at the highest concentration investigated by us. This spectral feature is generally attributed to the presence of porphyrin oligomers (Reddi E, Ceccon M, Valduga G, Joni G, Bommer J C, et al. (2002) Photophysical properties and antibacterial activity of meso-substituted cationic porphyrins. Photochem Photobiol 75: 462-470). To test the possibility that the hydrophobicity imparted by the long alkyl chain of C14 may favour the occurrence of some aggregation as the concentration increases, the titration was extended to larger molarities calculating the absorbance values at 404 nm instead of 424 nm (FIG. 2B). The plot for C14 clearly deviates from linearity at porphyrin concentrations between 1.0 and 1.5 mM, indicating that this porphyrin aggregates in this concentration range.

The stability of C14 to the effect of full spectrum visible light was studied for a 2.5 μM porphyrin solution in PBS. The exposure of the porphyrin to visible light at a fluence rate of 20 mW/cm² for up to 60 minutes caused a decrease in the overall absorbance of less than 10%, which involved the whole set of bands in the blue, green and red spectral region. Therefore, this porphyrin appears to be endowed with a marked photostability, taking into account that most porphyrins undergo a 50% or larger photodegradation under similar irradiations conditions (Joni G, Spikes J (1984) Photobiochemistry of porphyrins. In: Smith K C, editor. Topics in photomedicine. New York: Plenum Press. pp. 183-319).

### Determination of Singlet Oxygen Quantum Yield.

It is known (Jori G, Spikes J (1984) Photobiochemistry of porphyrins. In: Smith K C, editor. Topics in photomedicine. New York: Plenum Press. pp. 183-319; Joni G, Coppellotti O (2007) Inactivation of pathogenic microorganisms by photodynamic techniques: mechanistic aspects and perspective applications. Anti-infective Agents Med Chem 6: 119-131) that porphyrin photosensitisation of biological systems largely proceeds via generation of singlet oxygen (¹O₂), a highly reactive oxygen derivative, as the most toxic intermediate. The quantum yield of ¹O₂ generation by the photoexcited C14 porphyrin was determined by a chemical quenching method, using 9,10-dimethyl-anthracene (DMA) as a target. A typical time-dependence of the photoinduced decrease in the fluorescence emission of DMA upon increasing irradiation times in the presence of C14, due to the conversion of the polycyclic aromatic derivative to its non-fluorescent 9,10-endoperoxide was obtained (FIG. 2 FIGURE). The emission spectrum of the DMA is characterized by the presence of three main bands in the 400-500 nm wavelength interval, all of which showed an identical rate of photoinduced decrease. The quantum yield of ¹O₂ photogeneration by C14 was found to be 0.46. Therefore, about 50% of the C14-absorbed photons are conveyed to the direct promotion of the photosensitised oxidative processes that elicit damages to cells and tissues.

### Example 19

### Formulation Studies

C14 means synthetic cationic porphyrin, meso-tri(N-methylpyridyl), meso-mono(N-tetradecylpyridyl)porphine tetrasulphonate (MW=1545.96).

A standard food pellet for laboratory rodents, namely 4RF18 GLP (Mucedola Srl, Italy), commonly used as mosquito larval food, was crushed using an electric blender and then sieved (mesh diameter 500 μm) to obtain powdered food pellet (PFP) with final particle diameter of 5-500 μm diameter. C14-PFP complexes were obtained by incubating PFP in C14 solutions. The loading of C14 on PFP and the dynamics of its release from the C14-PFP complexes in water were analysed by spectrophotometric quantification. Specifically, to evaluate the C14 binding rate on PFP, 70 mg of PFP were incubated in 500 ml of a 5 μM solution of C14, at 28° C. for 5 days, in the dark. The same C14 solution without PFP served as control. The amount of unbound porphyrin was then estimated by measuring the absorbance at 423 nm of the supernatant of aliquots of the solutions collected at various incubation times and centrifuged at 10,000 rpm for 10 minutes. To test the stability of the C14-PFP complexes in aqueous media, 6 mg of the formulate, containing 72 μg of C14, were incubated at 30° C. in 100 ml of buffer solutions at 4 different pH values, in the presence of light. The following buffers were used: 50 mM potassium phosphate buffer (pH 7.0 and 7.6), 50 mM Tris-HClbuffer (pH 8.4) and 50 mM glycine-NaOH (pH 9.5). The amount of porphyrin released in the media from the formulate complexes was measured as described above.

To assess the effect of different C14 loading concentrations on the photolarvicidal activity of the C14-PFP complexes, two photolarvicidal formulates were prepared. The formulates, named C14 PF-5 and C14 PF-50, were obtained by incubating overnight at room temperature under gentle shaking 25 mg of PFP in 500 ml of 5 μM and 50 μM aqueous solutions of C14, respectively. The solutions were filtered using Whatman qualitative filter papers (Whatman International Ltd., UK) and the solid residues, consisting in the C14-PFP complexes, were washed with 10 ml distilled water, oven-dried at 37° C. for 4 hours and stored at room temperature until use. To quantify the amount of bound C14, samples of the two C14-PFP formulates were dissolved in 3 ml of 2% SDS for 2 h under gentle magnetic stirring. The extracted porphyrin was then quantified by spectrophotometric analysis as described above.

PFP incubated in a 5 μM C14 solution efficiently adsorbed the compound and sequestered it from the solution. Already 24 hours after the beginning of the incubation, 82% of C14 was bound to the PFP particles, and its amount increased to reach 92% after 5 days of incubation, while no appreciable decrease in C14 concentration was observed in a C14 solution incubated at the same conditions without PFP (FIG. 3A). The C14-loaded PFP appeared to stably retain the photosensitizer when transferred into C14-free buffer solutions and incubated for up to 24 hours. The C14 recovered from the incubation solutions after the incubation amounted 0.01 and 0.024 μM at the lowest and highest pH values tested, namely 7.0 and 9.5, respectively (FIG. 3B).

### Example 20

### Larvicidal Activity

Irradiation of mosquito larvae were performed by employing full spectrum visible light (400-800 nm) at a fluence rate of 1.0 to 4.0 mW/cm² using low-pressure mercury discharge fluorescent tubes TL-D Standard Colours (TL-D 58W/33-640 1SL, PHILIPS, EC). The intensity of the incident radiation was measured by an ILT1400A radiometer/photometer, equipped with a SED623/HNK15 multi-junction thermopile detector (International Light Technologies Inc., MA, USA).

The Aedes aegypti mosquito colony was maintained at 28±2° C., >90% Relative Humidity and a photoperiod of 12 h. For egg production, females were offered anesthetized BALB/c mice to take a blood meal. Gravid females were provided with wet filter paper disks. After oviposition, papers were allowed to dry and kept for one to two weeks at 28° C. and >90% Relative Humidity, before transferring them in spring water for hatching. Larvae were fed with ground food pellet for laboratory rodents (Mucedola Srl, Italy). Pupae were transferred to small plastic trays and placed into screened cages for adult emergence. A 5% sucrose solution in soaked cotton pads was offered to adults ad libitum.

All the experiments were carried out in a climatic chamber at 28±2° C. with a regulated photoperiod of 12 hours. Transparent plastic trays, containing 500 ml C14 solutions or spring water were employed. Typically, 5±1 days old, 3rd-early 4th instar Aedes aegypti larvae were used. All the experiments were replicated three times.

Mortality data were analyzed by ANOVA and LSD post-hoc tests using SPSS v. 11.0 (SPSS Inc.). LC₅₀ values and relevant statistics were obtained by nonlinear regression of mortality data, using OriginPro v. 7.5 (OriginLab Corp.).

### C14 Porphyrin Toxicity in the Dark

To assess whether C14 possessed an intrinsic toxicity in absence of irradiation, groups of about fifty larvae were added to trays containing 5 μM C14 solution, or well water as a control, provided with PFP (wherein PFP means powdered food pellet (PFP) with final particle diameter of 5-500 μm diameter obtained by crushing a standard food pellet for laboratory rodents, namely 4RF18 GLP (Mucedola Srl, Italy) using an electric blender and then sieving at mesh diameter 500 μm) and then incubated in the dark for 3, 8 and 24 hours. At the end of the incubation period, dead and living larvae were counted in each tray. Larvae were then washed with tap water, and transferred to new trays containing spring water and PFP. Trays were kept in the dark until adults emerged. Adults were counted and exposed to light (intensity 1.0-4.0 mW/cm²) for 12 hours, and their mortality was evaluated at the end of the irradiation period.

No mortality was recorded on Aedes aegypti larvae incubated in a 5 μM C14 solution in the dark, irrespectively of the duration of incubation, as shown in Table 9.

TABLE 9

| incubation time | larval % survival | | emerged adults | | adult % survival after |
|---|---|---|---|---|---|
| (hours)^{a} | (SD)^{b} | | (%)^{c} | | light exposure^{d} |
| 3 | 100 | (0.0) | 138/141 | (97.9) | 100 |
| 8 | 99.3 | (1.2) | 128/128 | (100) | 100 |
| 24 | 100 | (0.0) | 138/141 | (97.9) | 100 |
| control | 99.4 | (1.1) | 155/157 | (98.7) | 100 |

^{a}incubation was carried out with 5 μM C14.
^{b}surviving larvae at the end of the incubation period (n = 3 replicates of ~50 larvae each).
^{c}pooled data
^{d}12 h-long irradiation (1.0-4.0 mW/cm²).

All the exposed larvae pupated normally (data not shown), and the proportion of adults emerged was comparable to that of untreated controls (Table 8). No mortality was observed after the adults were exposed to light. The experiment demonstrates lack of toxicity by C14 in the dark, and lack of delayed effects on emerged adults.

### C14 Porphyrin Toxicity in the Light

Fifty larvae were added to groups of trays containing 5 μM porphyrin C14 solution or spring water as a control. Trays were provided with PFP (wherein PFP means powdered food pellet (PFP) with final particle diameter of 5-500 μm diameter obtained by crushing a standard food pellet for laboratory rodents, namely 4RF18 GLP (Mucedola Srl, Italy) using an electric blender and then sieving at mesh diameter 500 μm) and incubated in the dark for 12 hours. After the dark incubation period, C14-containing trays were divided into two groups and irradiated for 1 hour and 6 hours, respectively, at a light intensity of 1.0-4.0 mW/cm². Control trays were irradiated for 6 hours. After irradiation, the trays were returned in the dark, and larval mortality was assessed every 24 hours for the following 6 days. Larvae not moving or not showing a normally vigorous escaping response at probing were defined as dead or dying, respectively, and counted together. Pupae formed during the experiment were transferred to smaller trays containing spring water, within screened cages at normal colony photoperiod conditions, and monitored for mortality and adult emergence.

### C14 Porphyrin Toxicity in the Light

A 6 hour-long exposure to light (fluence rate 1.0-4.0 mW/cm²) of larvae previously dark-incubated for 8 hours in a 5 μM C14 solution determined an almost complete mortality within the irradiation period (97.99%±0.05%; (FIG. 4) and mortality reached 100% at the following count, carried out 24 hours later. The photosensitizing effect was irreversible, as demonstrated by the mortality of treated larvae irradiated for one hour and thereafter kept in the dark, which showed a continuous increase during the days following irradiation, and reached 92.1%±7.9% on day 6 (FIG. 4).

### Larvicidal Efficacy of C14 Porphyrin

Trays containing C14 porphyrin solutions at 7 increasing concentrations (range 0.03-4.3 μM), or spring water as a control, were provided with 6 mg of PFP each (wherein PFP means powdered food pellet (PFP) with final particle diameter of 5-500 μm diameter obtained by crushing a standard food pellet for laboratory rodents, namely 4RF18 GLP (Mucedola Srl, Italy) using an electric blender and then sieving at mesh diameter 500 μm) and then incubated in the dark for 48 hours. Batches of 100 larvae, fasted for the previous 24 hours, were introduced into the trays at 8.00 pm (beginning of the 12 hour-long dark period in the climatic chamber). Larval mortality was evaluated on the next day at 9 am (after 1 hour irradiation), 2 pm (6 hours irradiation) and 8 pm (12 hours irradiation). An additional mortality evaluation was performed on the following day at 8.00 am, after a further overnight incubation. Larvae not moving or not showing a normally vigorous escaping response at probing were defined as dead or dying, respectively, and counted together. Pupae occasionally formed during the experiment, which never exceeded 10% of the total number of larvae, were discarded and excluded from the evaluation.

Larvicidal efficacy of C14 porphyrin. The LC₅₀ values of C14 on 3^{rd}-4^{th} instar Ae. aegypti larvae showed an inverse relationship with the irradiation time (FIG. 5). After 1 h irradiation at a fluence rate of 1.0-4.0 mW/cm², the C14 LC₅₀ was 0.46 μM (Table 10), and its value halved after 12 h irradiation. An additional overnight incubation in the dark of larvae already irradiated for 12 h further decreased the C14 LC₅₀ to 0.11 μM, corresponding to less than ¼ of the value obtained after 1 h irradiation (Table 10).

TABLE 10

| hours of irradiation | LC₅₀ (μM) | C195% | R² | X² |
|---|---|---|---|---|
| 1 | 0.46 | 0.39-0.53 | 0.94084 | 0.29375 |
| 6 | 0.25 | 0.16-0.35 | 0.99381 | 0.03925 |
| 12 | 0.22 | 0.17-0.28 | 0.93035 | 0.39925 |
| 12 light + 12 dark | 0.11 | 0.08-0.13 | 0.94142 | 0.313 |

C14 solutions were incubated with 6 mg PFP at 28±2° C. in the dark for 48 hours. Larvae (3rd-4th instar, n=100, 3 replicates) were introduced 12 hours before the start of the irradiation (fluence rate: 1.0-4.0 mW/cm²).

### Larvicidal Efficacy of C14 Porphyrin-Loaded PFP

Trays containing 5 μM C14 porphyrin solution and 70 mg PFP (wherein PFP means powdered food pellet (PFP) with final particle diameter of 5-500 μm diameter obtained by crushing a standard food pellet for laboratory rodents, namely 4RF18 GLP (Mucedola Srl, Italy) using an electric blender and then sieving at mesh diameter 500 μm) were incubated at 28±2° C. for 5 days in the dark. The solution was then filtered using Whatman qualitative filter papers (Whatman International Ltd., UK). The eluted C14 solution was conserved, and the incubated PFP retained on the filter paper was washed with 10 ml distilled water before further use. Experimental groups were designed as follows: 1) filtered, C14-incubated PFP in spring water (group A); 2) C14 solution eluate, added with 70 mg fresh PFP (group B); 3) 5 μM C14 solution incubated without PFP for 5 days in the dark, added with 70 mg fresh PFP (group C); 4) freshly prepared 5 μM C14 solution, added with 70 mg PFP (group D); 5) spring water added with 70 mg fresh PFP (control group). Fifty larvae, fasted for 24 hours, were added to each tray and incubated in the dark for 12 hours. The treated or untreated PFP was added at the time of introduction of the larvae, in all the experimental groups. The trays were then exposed to a light intensity of 1.0-4.0 mW/cm² and dead, dying and living larvae were counted 1 to 3 hours after the beginning of the irradiation.

This experiment was carried out to investigate the route of intake and site of action of porphyrin C14 in the mosquito larvae. Larvae incubated in clean spring water added with PFP pre-incubated with the photosensitizing agent (group A) showed 92.2% mortality after irradiation (FIG. 6). No statistical difference was observed between this mortality level and the 87.1% and 78.2% mortalities achieved, respectively, by a freshly prepared C14 solution containing untreated PFP and a 5 μM C14 solution which had been incubated in the dark for 5 days before the introduction of untreated PFP (groups D and C). A lower mortality of 38.4% (p ≦0.002) was observed in larvae exposed to the porphyrin solution “eluate”, i.e. the solution obtained by filtrating the PFP from its incubation medium (group B, see methods for details). In this treatment group, the highest percentage of dying larvae (49.8%; p ≦0.002) was also observed, in contrast with all the other experimental groups where dying larvae amounted to 6.5%-19.1%. These mortality data confirm that C14 was loaded onto the “carrier” PFP, and show that C14 efficiently exerts its photosensitizing effect when adsorbed onto the PFP. The incubation solution, after being deprived of the C14-loaded PFP, has a lower C14 concentration and causes less mortality to the larvae. Incubating a C14 solution for five days in the absence of PFP resulted in a larvicidal medium that was equally effective as freshly prepared C14 solutions or C14-loaded PFP, indicating that the lower activity observed in the “eluate” (group B) is not due to degradation of the porphyrin in water.

### Fluorescence Microscopy

Additional samples of larvae were exposed to the same conditions as described in the above experiment and examined at the fluorescence microscope to determine C14 localization in the larva after uptake and to observe organ morphology. Samples of treated and untreated PFP were also examined to qualitatively assess C14 adsorption. A Zeiss Axio Observer Z1 (Carl Zeiss AG, Oberkochen, Germany) at 50×-400× magnification in fluorescence light, and a FITC09 filter (excitation bandpass 450-490 nm; emission longpass 515 nm) were used.

When photoexcited at 450-490 nm, C14 emits a red fluorescence which allowed a qualitative assessment and comparison of the photosensitizer uptake by the larvae. In all the treated larvae, such fluorescence appeared to be limited to the midgut and the gastric caeca. A strong fluorescence was observed in the midgut of larvae exposed to all the C14 treatments (groups A, C and D), exception made for the incubation eluate group, in which the larvae displayed a clearly less intense fluorescence in their gut and caeca (group B). A mild green fluorescence was observed in control larvae, owing to the presence of untreated PFP particles in their midgut. The presence/intensity of the C14 fluorescence pattern in the larvae matched what observed in PFP particles sampled from the corresponding larval incubation media. These observations show that C14 converges into the digestive tract, and that the route of intake of the compound is by ingestion of C14-PFP complexes, even when the photosensitizing agent is initially dissolved in water. Treated and irradiated larvae were often found to expel fluorescent particulate material from the anus, which appeared to be enveloped by the gut epithelium or the peritrophic matrix, probably as a consequence of photoinduced damages to the digestive tract.

### Efficacy and Residual Activity of Photolarvicidal Formulations

Five series of trays were prepared, namely 0.3 μM and 5 μM C14 porphyrin solutions containing 6 mg PFP (wherein PFP means powdered food pellet (PFP) with final particle diameter of 5-500 μm diameter obtained by crushing a standard food pellet for laboratory rodents, namely 4RF18 GLP (Mucedola Srl, Italy) using an electric blender and then sieving at mesh diameter 500 μm); spring water containing 6 mg C14 PF-5 or C14 PF-50 formulate (wherein C14 PF-5 and C14 PF-50, were obtained by incubating overnight at room temperature under gentle shaking 25 mg of PFP in 500 ml of 5 μM and 50 μM aqueous solutions of C14, respectively) and spring water containing 6 mg PFP as a control. Each series was arranged into three groups, which were incubated at a 12 hour photoperiod for 48 hours, one, or two weeks, respectively. At the end of the incubation periods, batches of 100 larvae, having fasted for 24 hours, were introduced into the trays, at 8 pm (beginning of the 12 h-long dark period in the climatic chamber). Larval mortality was evaluated after 12 hours (next day at 8.00 pm) of irradiation.

The quantification of C14 loaded onto the PFP in the two experimental formulates C14 PF-5 and C14 PF-50 revealed that the porphyrin amounted 1.18 μg and 58.7 μg per mg of formulate, respectively. C14 PF-50 maintained its larvicidal activity when incubated in trays containing spring water under the “natural” 12 h photoperiod of the climatic chamber (temperature 28±2° C.; fluence rate 1.0-4.0 mW/cm²) for two weeks, the maximum time tested (Table 11).

TABLE 11
% mortality by incubation time*

| | | | | | | | C14 (mg)/ |
|---|---|---|---|---|---|---|---|
| treatment | 48 hours | | 1 week | | 2 weeks | | tray |
| control^{†} | 0 | (0.0) | 0 | (0.0) | 0 | (0.0) | 0 |
| 0.3 μM^{†} | 100 | (0.0) | 100 | (0.0) | 0 | (0.0) | 0.230 |
| 5 μM^{†} | 100 | (0.0) | 100 | (0.0) | 100 | (0.0) | 3.800 |
| C14PF-5 ^{‡} | 0.3 | (0.6) | 0.3 | (0.6) | 0 | (0.0) | 0.007 |
| C14PF-50 ‡ | 100 | (0.0) | 99.7 | (0.6)§ | 99.7 | (0.6)§ | 0.352 |

Mortality was assessed after 12 h irradiation (intensity 1.0-4.0 mW/cm²).
*time elapsed between the preparation of the trays and the introduction of 3rd-4th instar larvae (n = 100 larvae; 3 replicates). During this period, trays were incubated in the climatic chamber (12 h photoperiod; 28 ± 2° C.; >90% RH). Numbers in parentheses indicate standard deviations, where applicable.
^{†}trays contained 6 mg of untreated larval food in C14 porphyrin solutions at the indicated concentration.
‡ trays contained 6 mg of the indicated formulation in spring water.
§one surviving larva was found in the tray. Such larvae were negative for C14 fluorescence at the microscope, therefore they hadn't fed during the experiment.

Conversely, C14 PF-5 resulted devoid of any insecticidal activity, even just 48 hours after preparation. When C14 porphyrin was dissolved in water containing 6 mg of untreated PFP, a concentration-dependant residual activity was obtained: 1 week for 0.3 μM solutions and two weeks for 5 μM solutions. The absolute C14 amounts to which the larvae were exposed are in agreement with the photolarvicidal activities observed (table 11).

1. A composition comprising
at least one porphyrin and at least one carrier
wherein the carrier establishes a stable, non-covalent association with the porphyrin by electrostatic and hydrophobic interactions and the carrier is selectively palatable by mosquito larvae, wherein the carrier is not autolysed yeast.

2. The composition according to claim 1, wherein the porphyrin and the carrier are in the form of a complex.

3. The composition according to claim 1, wherein the carrier is stably associated with the porphyrin at temperatures below 50° C. and pH ranging from 5.0 to 8.0.

4. The composition according to claim 1, wherein the carrier is stably associated with the porphyrin in dryness, at temperatures below 50° C. and relative humidity up to 80%.

5. The composition according to claim 1, wherein the carrier is stably associated with the porphyrin for at least 6 months in storage conditions.

6. The composition according to claim 1, wherein the carrier is stably associated with the porphyrin for at least 2 weeks in water.

7. The composition according to claim 1, wherein the carrier has a diameter between 5 μm and 50 μm.

8. The composition according to claim 1, wherein the carrier is synthetic or natural, or a mixture thereof.

9. The composition according to claim 8, wherein the synthetic carrier is selected from the group consisting of Eudragit®, methacrylate derivatives, polyvinylpyrrolidone, PEG (polyethylene glycol) derivatives; liposomes, polypeptides, oligo- or poly-saccharides, starch, amylopectin, Ca++/alginate, poly(lactic acid) (PLA) optionally conjugated with PEG or their co-polymers, poly(lactic-co-glycolic acid) (PLGA) optionally conjugated with polyethylene glycol or their co-polymers, cellulose derivatives, dextranes, dextranes copolymers, poly(acrylic acid) (PAA), poly(acrylic acid) (PAA) co-polymers, poly(vinyl alcohol) (PVA), poly(vinyl alcohol) (PVA)co-polymers, poly(ethylene oxide), poly(ethylene oxide) co-polymers, poloxamers, poloxamers co-polymers, polyethyleneimine (PEI), and polyethyleneimine (PEI) co-polymers.

10. The composition according to claim 8, wherein the natural carrier is selected from the group consisting of pellet food for carnivorous animals, pellet food for herbivorous animals, vegetable coal, pollen, vegetable flours, and seeds.

11. The composition according to claim 9, wherein the synthetic carrier is Eudragit®.

12. The composition according to claim 11, wherein Eudragit is Eudragit S 100®.

13. The composition according to claim 10 wherein the natural carrier is pollen.

14. The composition according to claim 13, wherein pollen is pollen from plants belonging to Boraginaceae, Lamiaceae and Brassicaceae.

15. The composition according to claim 10, wherein the pellet food for carnivorous animals is a protein-rich fraction from a commercial cat food pellet preparation wherein protein content is 80%, fat content is 10%, and carbohydrates, minerals and vitamins content is 10%.

16. The composition according to claim 1, wherein the porphyrin is anionic.

17. The composition according to claim 1, wherein the porphyrin is cationic.

18. The composition according to claim 1, wherein the porphyrin is of formula (I): 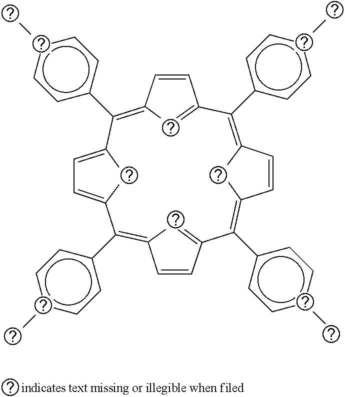
wherein:
R₁═R₂═R₃ is —CH₃
R₄ is a straight or branched saturated or unsaturated C₁-C₂₂ hydrocarbon chain,
all the possible stereoisomers, Z and E isomers, optical isomers and their mixtures.

19. The composition according to claim 18, wherein R₄ is selected from the group consisting of: —CH₃, —CH₂(CH₂)₄CH₃; —CH₂(CH₂)₈CH₃; —CH₂(CH₂)₁₀CH₃; —CH₂(CH₂)₁₂CH₃; —CH₂(CH₂)₁₆CH₃ and —CH₂₀(CH₂)₈CH₃.

20. The composition according to claim 19, wherein R₄ is selected from the group consisting of: —CH₂(CH₂)₁₀CH₃ and —CH₂(CH₂)₁₂CH₃.

21. A composition comprising meso-tri(N-methyl-pyridyl), mono(N-dodecyl-pyridyl)porphine and Eudragit®.

22. The composition of claim 21, wherein meso-tri(N-methyl-pyridyl), mono(N-dodecyl-pyridyl)porphine and Eudragit® are in the form of a complex.

23. A composition comprising meso-tri(N-methyl-pyridyl), mono(N-tetradecyl-pyridyl)porphine and Eudragit®.

24. The composition of claim 23. wherein meso-tri(N-methyl-pyridyl), mono(N-tetradecyl-pyridyl)porphine and Eudragit are in the form of a complex.

25. (canceled)

26. (canceled)

27. (canceled)

28. A mosquito larvae food formulation comprising the composition of claim 1.

29. A method for controlling mosquito larvae development comprising feeding larvae with the larvae food formulation of claim 28.

30. A method for controlling mosquito larvae development comprising applying in the environment the composition of claim 1.

31. A kit for the control of mosquito larvae development comprising the composition of claim 1 suitable means for applying said composition in the environment.
